(19) United States
(12) Patent Application Publication
(10) Pub. No.: US 2023/0347841 A1
(43) Pub. Date: Nov. 2, 2023

(54) VEHICLE ELECTRICAL POWER APPARATUS

(71) Applicant: Consolidated Metco, Inc., Vancouver, WA (US)

(72) Inventors: Bret Hunley, Vancouver, WA (US); David Reuter, Saline, MI (US); Shantanu Chaturvedi, Vancouver, WA (US)

(21) Appl. No.: 18/140,189

(22) Filed: Apr. 27, 2023

Related U.S. Application Data
(60) Provisional application No. 63/337,332, filed on May 2, 2022.

(51) Int. Cl. B60R 16/033; B60W 10/26

(52) U.S. Cl. CPC B60R 16/033; B60W 10/26; B60P 3/20

(57) ABSTRACT

In one aspect, a vehicle electrical power apparatus that includes an electrical input, an electrical output, a battery interface, and a switch. The electrical input is configured to receive electrical power from an external power source. The electrical output connects to an electrically powered device of the vehicle. The switch has a plurality of configurations including a battery charging configuration and a battery power configuration. In the battery charging configuration, the electrical input and the battery interface are electrically connected to permit the battery interface to receive electrical power from the electrical input. In the battery power configuration, the battery interface and the electrical output are electrically connected to permit the electrical output to receive electrical power from the battery interface.

### CROSS-REFERENCE TO RELATED APPLICATION

This application claims the benefit of U.S. Provisional Application No. 63/337,332, filed May 2, 2022, which is hereby incorporated herein by reference in its entirety.

### FIELD

This disclosure relates to electrical power systems for vehicles and, in particular, relates to electrical power systems for vehicles having electrically powered devices.

### BACKGROUND

Many commercial vehicles include refrigeration units, such as transport refrigeration units (TRUs), to keep perishable items cool during transport. TRUs were conventionally powered by a generator having a diesel internal combustion engine. An increasing number of commercial vehicles include TRUs that are electrically powered by a battery instead of, or in combination with, a diesel generator. The battery may be charged by connecting the vehicle to a shore power source, typically 480 VAC, when the vehicle is stopped.

A recent trend in commercial vehicles is the use of hybrid powertrains. For example, a commercial vehicle may have an internal combustion engine as a first motive source and an electric motor as a second motive source. The electric motor may be powered using energy stored in a battery of the vehicle. The battery may be charged by a regenerative braking system of the vehicle or by connecting a cord of a charging station to a plug of the vehicle. The charging station and cord may be proprietary to the manufacturer of the vehicle or may be designed pursuant to a common charging standard. In either situation, a large number of charging stations may need to be deployed across a geographic area to provide adequate charging opportunities for a commercial vehicle traveling in the geographic area.

### SUMMARY

In one aspect of the present disclosure, an electrical power apparatus is provided for a vehicle. The electrical power apparatus includes an electrical input to receive electrical power from an external power source, an electrical output to provide electrical power to an electrically powered device of the vehicle, and a battery interface to provide electrical power to a battery of the vehicle and receive electrical power from the battery. The external power source may be a conventional shore power source, such as 480 VAC, that is ubiquitous throughout the geographic area of operation of the vehicle, such as truck stops, maintenance facilities, rail yards, etc. in the geographic area. The battery of the vehicle may be a battery of a regenerative braking system of the vehicle.

The electrical power apparatus further includes a switch operatively connected to the electrical input, the electrical output, and the battery interface. The switch has a plurality of configurations including a battery charging configuration and a battery power configuration. With the switch in the battery charging configuration, the electrical input and the battery interface are electrically connected to permit the battery interface to receive electrical power from the electrical input. With the switch in the battery power configuration, the battery interface and the electrical output are electrically connected to permit the electrical output to receive electrical power from the battery interface. In this manner, the battery of a vehicle regenerative braking system may be charged via the external power source (e.g., a conventional 480 VAC power source) and the electrically powered device may be powered using the battery. This approach stands in contrast to some prior approaches, wherein a shore power source is used to power a TRU of a commercial vehicle and a different charging station is used to charge the battery of the vehicle's regenerative braking system.

In some embodiments, the electrical output of the electrical power apparatus is configured to be connected to a refrigeration unit of a vehicle. In other embodiments, the electrical output of the electrical power apparatus may be configured to connect to another vehicle system such as an air compressor, a light system, and/or a liftgate instead of or in addition to the refrigeration unit. The electrical power apparatus may be used to power various electrically powered devices of the vehicle that utilize either AC or DC electrical power. The electrical power apparatus may be configured to deliver the requisite electrical power to the electrically powered devices, for example, power at a required voltage level. In some forms, the electrical power apparatus may operate in a vehicle-to-vehicle power mode where one vehicle provides electrical power to another vehicle. For example, where two trailers are electrically connected to one another, a first trailer may provide electrical power to a second trailer or to electrical devices of the second trailer.

In one embodiment, the electrical power apparatus includes a control unit. For example, the control unit may be integrated with the switch or may be in communication with the switch. The control unit is configured to set the switch to one of the plurality of configurations based upon a determination of whether the external power source is able to provide electrical power to the electrical input. For example, the electrical power apparatus may include a proximity sensor configured to detect a presence of a cord of the shore power source connected to the electrical input and the control unit receives data from the proximity sensor indicative of the presence of the shore power source cord. The control unit is configured to set the switch to one of the plurality of configurations based at least in part on whether the electrical input is connected to the shore power source.

In one embodiment, the electrical power apparatus includes a sensor configured to detect a variable of the refrigeration unit. For example, the variable may include, for example, a run state of the refrigeration unit (e.g., running or not running), current, voltage, power, and/or efficiency. The electrical power apparatus includes a control unit operatively connected to the sensor. The control unit is configured to set the switch to one of the plurality of configurations based at least in part on whether the electrical input is connected to the external power source and the variable of the refrigeration unit.

The present disclosure also provides a method of operating an electrical power apparatus of a vehicle having a battery and an electrically powered device. The method includes detecting a variable of the electrically powered device and determining whether an external power source is able to provide electrical power to an electrical input of the electrical power apparatus. The method includes setting a switch of the electrical power apparatus to one of a plurality of configurations based at least in part on the variable of the electrically powered device and whether the external power source is able to provide electrical power to the electrical input. The plurality of configurations of the switch include a battery charging configuration and a battery power configuration. With the switch in the battery charging configuration, the electrical input and the battery are electrically connected to permit the battery to receive electrical power from the external power source. With the switch in the battery power configuration, the battery and the electrically powered device are electrically connected to permit the electrically powered device to receive electrical power from the battery. The method facilitates selectively charging the battery using an external power source or powering the electrically powered device using the battery.

In another aspect, the present disclosure provides a vehicle system including a regenerative braking system having a battery, an electrical input configured to be connected to an external power source, an electrically powered device, and a switch. The switch has a battery charging configuration wherein the electrical input and the battery are electrically connected to permit the battery to receive electrical power from the external power source. The switch also has a battery power configuration wherein the battery and the electrically powered device are electrically connected to permit the electrically powered device to receive electrical power from the battery. The vehicle system includes a control unit configured to set the switch to one of the plurality of configurations based at least in part on a variable of the electrically powered device and a determination of whether the external power source is able to provide electrical power to the electrical input. The vehicle system thereby configures the switch to facilitate battery charging and/or battery-powered operation of the electrically powered device based on the variable of the electrically powered device and whether the external power source can provide electrical power.

For example, the vehicle system may include a current sensor and the variable includes a current draw of the electrically powered device. The current draw may be, as examples, the actual current draw or an estimate of a current draw calculated and requested by the electrically powered device.

Whether the external power source is able to provide electrical power to the electrical input may be determined using various approaches. For example, the vehicle system may include a proximity sensor of the electrical input and configured to detect the proximity of a plug or a cord of the external power source. The proximity sensor may include, for example, a switch that mechanically detects the proximity of the plug of the external power source. The switch may be closed when the electrical input is connected to the plug of the external power source and the switch may be opened when the electrical input is disconnected from the plug. As another example, the electrical input may have a voltage detection circuit that detects the presence of voltage on the shore power plug or cord.

The present disclosure also provides a control unit for a vehicle having a battery, a switch, and a refrigerator unit with a generator. The control unit includes communication circuitry configured to communicate with the switch and the refrigerator unit. The control unit further includes a processor operatively connected to the communication circuitry. The processor is configured to determine a variable of the generator providing electrical power for the refrigerator unit. The processor is further configured to cause the switch to electrically connect the battery to the generator and permit the battery to receive power from the generator upon a determination that the generator providing electrical power for the battery and the refrigerator unit would improve the operation of the generator. A generator of a refrigerator unit is typically more efficient when the generator is operating at 80% to 90% of their maximum capacity. The control unit may identify when the generator is providing power for the refrigeration unit outside of the peak efficiency of the generator and cause the switch to connect the battery to the generator and increase the load on the generator when doing so would move the generator to its peak efficiency.

In another aspect, the present disclosure provides an electrical power apparatus for a vehicle. The electrical power apparatus includes an electrical input to receive electrical power from an external power source (e.g., a shore power source and/or an energy harvesting device of the vehicle). The electrical power apparatus includes an electrical output configured to connect to an electrically powered device (e.g., a refrigeration unit) of the vehicle. The electrical power apparatus includes a switch configured to selectively connect the electrical input to the electrical output to permit electrical power to flow from the external power source to the electrical output. The electrical power apparatus includes a control unit configured to receive electrical power from a primary power supply of the vehicle or an auxiliary power supply.

The control unit has a normal mode wherein the control unit is receiving a signal, such as a communication signal, from the primary power supply and the control unit is operable to set the switch to any one of the plurality of configurations. In the normal mode, the control unit is able to receive electrical power from either the primary power supply or the auxiliary power supply.

The control unit has an isolation mode where the control unit is not receiving the signal from the primary power supply. In the isolation mode, the control unit is electrically powered by the auxiliary power supply and the control unit is unable to set the switch to either the battery charging configuration or the battery power configuration. The control unit reconfigures from the normal mode to the isolation mode when the signal from the primary power supply is lost.

### BRIEF DESCRIPTION OF THE DRAWINGS

FIG. 1 is a perspective view of a vehicle including a tractor and a trailer, the trailer including a regenerative braking system and an electrical power apparatus.

FIG. 2 is a block diagram of the electrical power apparatus in communication with the regenerative braking system and other components of the vehicle.

FIG. 3A is schematic diagram of the electrical power apparatus according to one embodiment, the electrical power apparatus connected to a battery of the regenerative braking system, a commercial refrigeration unit, and a shore power source.

FIG. 3B is a schematic diagram of a switch of the electrical power apparatus of FIG. 3A.

FIG. 4 is a table illustrating the various configurations of the switch of the electrical power apparatus of FIG. 1.

FIG. 5 is a flow diagram of an example method of operating the electrical power apparatus.

FIGS. 6A-6B show a schematic diagram of the electrical power apparatus according to another embodiment.

FIG. 7 is a block diagram of an electrical power apparatus of the trailer of FIG. 1 according to another embodiment, the electrical power apparatus in communication with other components of the vehicle.

FIGS. 8A, 8B, 8C is a schematic diagram of the electrical power apparatus of FIG. 7, the electrical power apparatus connected to the battery of the regenerative braking system, the commercial refrigerator unit, and a shore power source.

FIG. 9 is a table illustrating the various configurations of a switch of the electrical power apparatus of FIG. 7.

FIG. 10 is a table illustrating various configurations of a switch of another embodiment of an electrical power apparatus.

### DETAILED DESCRIPTION

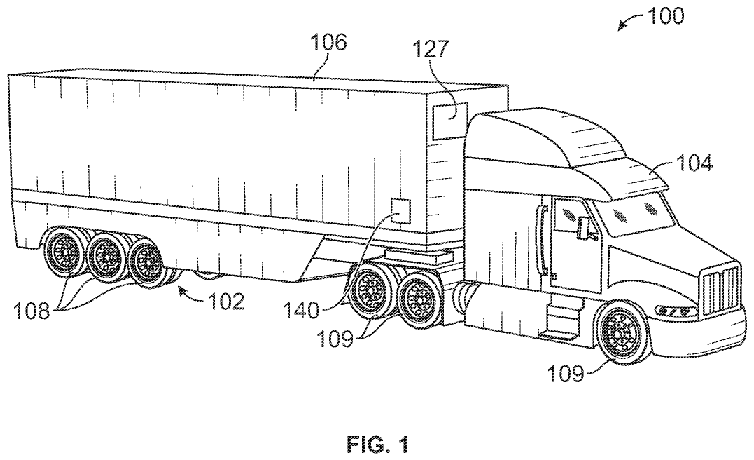

With respect to FIG. 1, a vehicle such as a semi-truck 100 is shown having a regenerative braking system 102, a tractor 104, and a trailer 106. The regenerative braking system 102 may be coupled to one or more wheels 108 of the trailer 106 and/or one or more wheels 109 of the tractor 104 to generate electrical power. Alternatively or additionally, the regenerative braking system 102 may be coupled to one or more wheels 109 of the tractor 104. While a semi-truck 100 is shown as an example application, those having skill in the art will readily appreciate that the following discussion also applies to a box truck, cube van, locomotive, rail car, intermodal shipping container, cement mixer, mobile crane, recreational vehicle (RV), pumper or vacuum truck, mobile police or government agency command center, filmmaking support vehicle, or food truck.

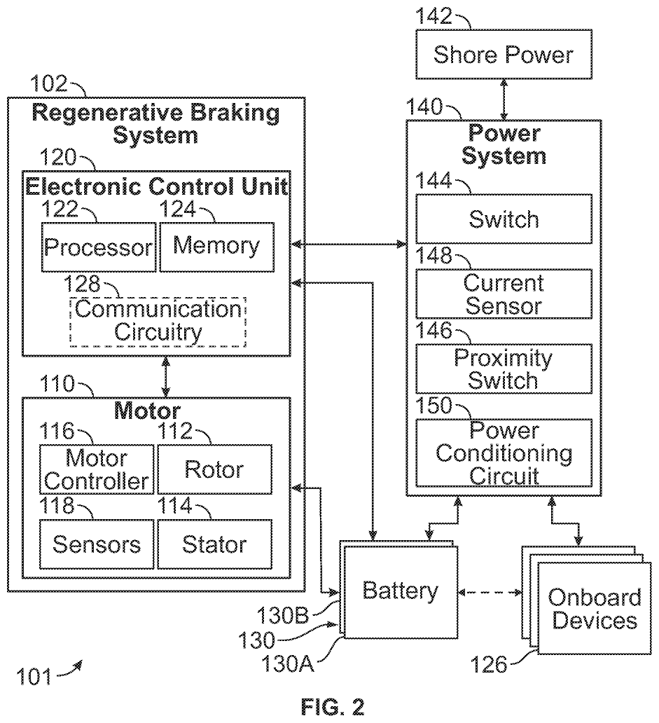

With respect to FIG. 2, the semi-truck 100 includes an electrical system 101 including the regenerative braking system 102, a power system 140, and a battery 130. The battery 130 may include a battery 130A that is a high voltage (e.g., 400V) direct current (DC) battery 130A for powering high voltage onboard devices 126 of the vehicle such as one or more electric motors 110 of the regenerative braking system 102 and/or a refrigeration unit 127 (see FIG. 1) of the semi-truck 100. The battery 130A may be a single battery or two or more batteries. The battery 130 may also include a battery 130B that is a low voltage (e.g., 12V) DC battery for powering an electronic control unit 120. The battery 130B may be one or more batteries. The battery 130 may be charged by connecting the semi-truck 100 to a shore power source 142, such as a 460 volt three-phase alternating current (AC) power source at a truck stop or maintenance facility. Further, the regenerative braking system 102 charges the battery 130 of the semi-truck 100 while the semi-truck is in transit and/or away from a shore power source. In one embodiment, the battery 130A receives electrical power from the regenerative braking system 102 or the shore power source 142. The electrical system 101 directs electrical power from the battery 130A to the battery 130B upon, for example, the capacity of the battery 130B falling below a threshold value.

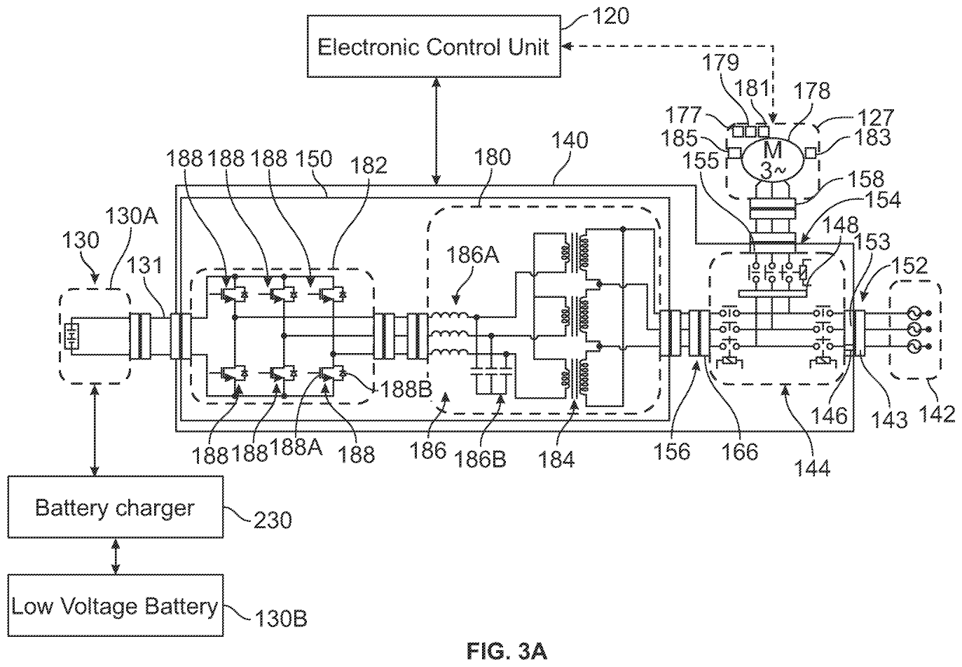

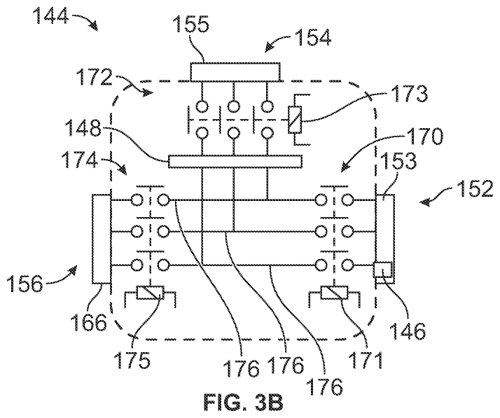

The refrigeration unit 127 may draw power from the battery 130 via a power system 140 of the semi-truck 100 to cool the enclosed area, for example, to keep contents of the trailer 106 cool. Regarding FIG. 3A, when an electrical input 152 of the power system 140 is connected to a shore power source 142, the power system 140 may be used to charge the battery 130 and/or to power the refrigeration unit 127. The power system 140 thus facilitates power conversion and transfer from the shore power source 142 to the battery 130 and/or refrigeration unit 127 and from the battery 130 to the refrigeration unit 127 as described in further detail below. The power system 140 thus enables the refrigeration unit 127 to be run and the battery 130 to be charged using existing and widely available infrastructure, e.g., 480 VAC three-phase, 208 VAC three-phase, or 240 VAC single phase three-phase shore power. In this manner, connecting the power system 140 to shore power source permits both charging the battery 130 and powering the refrigeration unit 127. In one embodiment, a single connector (e.g., an electrical cord) may be used to connect the electrical power apparatus 140 to the shore power source for both charging the battery 130 and powering the refrigeration unit 127.

Regarding FIG. 2, the regenerative braking system 102 includes a motor 110 having a rotor 112 and a stator 114. The motor 110 may be coupled to a wheel end assembly of the wheels 108, 109 of the semi-truck 100. The stator 114 of the motor 110 may be rotationally fixed relative to an axle and/or spindle of the truck 100. The rotor 112 may be coupled to a wheel-hub of the wheels, 108, 109 and configured to rotate about the stator 114. Thus, rotation of the wheel-hub of the wheel 108, 109, caused by movement of the semi-truck 100, may be used to generate electric power via operation of the motor 110 as a generator. The motor 110 may include a motor controller 116 that applies a torque via the motor 110 to the wheel 108, 109 to generate the electrical power. The semi-truck 100 may further include friction brakes (e.g., drum brakes or disc brakes) to stop the vehicle in conjunction with the regenerative braking system 102.

In some embodiments, the motor 110 used to generate electrical power may also be used to drive the vehicle such as in a hybrid or electric vehicle. For example, the motor 110 of the regenerative braking system 102 may be coupled to the wheels 109 of the tractor 104 and/or the wheels 108 of the trailer 106. Although motor 110 is described in the singular, it will be appreciated that the motor 110 may include one or more motors 110. The motor 110 may be used to drive the vehicle or to assist in moving the vehicle. Where the motor 110 is coupled to the wheel 108 of a trailer 106, the motor 110 may provide torque to the wheel hub of the trailer 106 to assist the tractor 104 in moving the trailer 106. For instance, the motor 110 may provide a torque to the wheel hub to produce movement of the trailer 106 in the desired direction of travel of the semi-truck 100, thereby reducing the amount of power required by the tractor 104 to move the trailer 106.

In other embodiments, the motor 110 is not coupled directly to the wheel hub of a wheel 108, 109, but rather is indirectly coupled to the wheel 108, 109 such that rotation of the wheel 108, 109 caused by the movement of the vehicle turns the rotor 112 of the motor 110. For example, the rotor 112 of the motor 110 may be coupled to an axle of the vehicle that is coupled to the wheel 108, 109 such that the axle turns with rotation of the wheel 108, 109. In another form, the motor 110 is coupled to the driveshaft of the vehicle such that rotation of the driveshaft causes the rotor 112 of the motor 110 to rotate and vice versa.

The regenerative braking system 102 includes the motor 110 and an electronic control unit such as an electronic control unit 120. The motor 110 includes the stator 114, the rotor 112, the motor controller 116, and one or more sensors 118. The motor controller 116 may include a memory and processor configured to control the operation of the motor 110. The motor controller 116 is configured to receive a command, such as a torque request, to apply a torque to the wheel 108, 109. The motor controller 116 is configured to execute the torque request that the motor controller 116 receives, causing the motor 110 to apply a torque to the wheel 108, 109 to apply a braking or a driving force to the vehicle. Where a braking force is applied, the motor 110 generates electrical power that may be used to charge a battery 130 of the truck 100 and/or to run an electrically powered device of the vehicle (e.g., a refrigeration unit). To apply a braking force, the motor controller 116 may apply and control the current in the stator 114 of the motor 110 to electrically interact with the rotor 112 and apply a torque to the wheel 108, 109 via the rotor 112 in the direction opposite the direction of rotation of the wheel, 108, 109. To apply a driving force, the motor controller 116 similarly applies and controls the current in the stator 114 to apply a torque to the wheel 108, 109 via the rotor 112 in the desired direction of rotation of the wheels 108, 109. The motor controller 116 induces a magnetic field in the rotor 112 with the stator 114 by controlling the current in the stator 114.

The sensors 118 of the motor 110 may be used to monitor aspects of the operation and health of the motor 110. The sensors 118 may be communicatively coupled to the motor controller 116 which may process the sensor data. The sensors 118 may include, for example, a speed sensor that monitors the rotational speed of the rotor 112 about the stator 114. The sensors 118 may also include a temperature sensor that monitors the temperature of the motor 110. For instance, the temperature sensor may monitor the temperature of the stator 114 of the motor 110. The temperature sensor may be a thermistor or thermocouple as examples.

The electronic control unit 120 controls and monitors the operation of the electrical systems of the vehicle 100. The electronic control unit 120 may be in communication with the motor controller 116, the battery 130, the power system 140. The electronic control unit 120 may send control signals to the motor controller 116 to operate the motor 110 and may receive motor operation and health information collected via the sensors 118 of motor 110. The electronic control unit 120 may communicate with the power system 140 (e.g., a control unit of the power system 140) to receive data from the power system 140 and/or to change a mode or configuration of the power system 140 as described in further detail below. The electronic control unit 120 may communicate with the battery 130 to determine operation and health information of the battery 130, for example, a charge level and/or a temperature of the battery 130. The electronic control unit 120 may communicate with the motor controller 116, the battery 130, and the power system 140 via a communication bus, for example, a CAN bus. The electronic control unit 120 may include a processor 122 and memory 124 and may be a computer associated with the vehicle (e.g., the trailer 106). The processor 122 may include, for example, a microprocessor, an application-specific integrated circuit (ASIC), and/or a system-on-a-chip. The memory 124 may include, for example, read-only memory (ROM), random access memory (RAM) such as DRAM and SRAM, and/or flash memory. The processor 122 and memory 124 may be provided on a circuit board. The electronic control unit 120 may also include communication circuitry 128 for communicating with other devices, such as the motor controller 116, battery 130, and/or power system 140, via wired and/or wireless connections. As examples, the communication circuitry 128 may be configured to communicate using one or more of a controller area network (CAN), wireless fidelity (Wi-Fi), cellular, radio frequency (RF), infrared (IR), Bluetooth (BT), Bluetooth Low Energy (BLE), Zigbee and near field communication (NFC). In some embodiments, the communication circuitry 128 is configured to communicate with a remote computer via a wide area wireless network and the internet.

The electronic control unit 120 may be configured to communicate with a portable electronic device such as a laptop computer, smartphone, tablet computer, or the like. In some forms, the electronic control unit 120 may be configured to communicate information with the portable electronic device regarding the status of the vehicle, the refrigeration unit, power system, and/or the regenerative braking system 102. For instance, the electronic control unit 120 may communicate the charge level of the battery 130 of the trailer 106 to the smartphone of the vehicle operator or computer of the tractor 104 during a pre-trip check of the semitruck 100. The electronic control unit 120 may also communicate whether the refrigeration unit 127 is running, whether the power system 140 is connected to a shore power source, and whether the refrigeration unit 127 is drawing power from the shore power source or the battery 130. In one form, the electronic control unit 120 may communicate status information to a remote server computer associated with a smartphone application installed on the vehicle operator's smartphone. The remote server computer may communicate status information provided by the electronic control unit 120 to the vehicle operator's smartphone for review by the vehicle operator and/or to a computer of a fleet manager. For example, the status information may be viewable on a website, within an application, and/or may be presented to the vehicle operator via a notification pushed to the vehicle operator's smartphone. As another example, the status information may be viewable on a dashboard display of the vehicle.

The battery 130 may be used to power one or more electrically powered devices such as onboard vehicle devices 126 of the semi-truck 100. The onboard vehicle devices 126 of the truck 100 may include the refrigeration unit 127, a communication system, a global navigation satellite system receiver, a powered liftgate, pallet truck charger, hydraulic equipment and/or devices on-board the tractor 104 and/or trailer 106. While the refrigeration unit 127 is primarily provided in the following discussion as the onboard device 126, it should be understood that other onboard devices, such as the examples provided above, may similarly be connected to and powered by the power system 140.

The electronic control unit 120 may include one more operatively connected electronic control units, such as electronic control unit of the regenerative braking system 102 and an electronic control unit of the power system 140. The electronic control unit of the regenerative braking system 102 may be powered by, for example, the battery 130B and/or a 12V DC power supply from the tractor 104. The electronic control unit of the power system 140 may be powered by the battery 130B. The battery 130B permits the electronic control unit of the power system 140 to operate independently of power from the tractor 104, such that the power system 140 may provide power to the refrigeration unit 127 even when the trailer 106 is disconnected from the tractor 104 and parked. In this manner, the power system 140 may operate to charge the battery 130A when the trailer 106 is connected to the shore power source 142 and run the refrigeration unit 127 from the battery 130A even when the trailer 106 is not connected to the tractor 104.

The battery 130 may be charged by the regenerative braking system 102, via the power system 140, and/or via an off-board DC charger such as a vehicle charging station. For instance, when the regenerative braking system 102 generates electrical power by applying a braking torque to a wheel 108, 109, the generated electrical power may be used to charge the battery 130. The battery 130 may also be charged via the power system 140. As described in further detail below, when the power system 140 is connected to an external power source such as shore power 142 (for example a 480 VAC three-phase power source) the power system 140 may be used to charge the battery 130. The electronic control unit 120, or another control unit (e.g., an electronic control unit in communication with the electronic control unit 120), may control the power system 140 to selectively cause power from the shore power 142 to be used to charge the battery 130.

The power system 140 includes a switch 144 for distributing electrical power from the shore power 142 or from the battery 130. The switch 144 also facilitates controlling the flow of electricity through the power system 140. The power system 140 includes a proximity switch 146 for detecting when the power system 140 is connected to shore power 142. The power system 140 further includes a current sensor 148 for detecting the amount of current flowing through the power system 140 to the refrigeration unit 127. The power system 140 further includes two-way power conditioning circuitry 150 for converting the DC power of the battery 130 into power usable by the refrigeration unit 127 and for converting the AC power of the shore power 142 to DC power to charge the battery 130.

With reference to FIGS. 3A-3B, the power system 140 is shown. The power system 140 includes the switch 144 and the power conditioning circuitry 150. The switch 144 includes an electrical input 152, an electrical output 154, and a power conditioning interface 156. The switch 144 may include a housing that is mountable to an exterior of the vehicle or may be included in a housing containing the power conditioning circuitry 150. The housing may contain the electrical input 152 and protect the electrical input 152 from damage and the elements.

The electrical input 152 may be connected to an external power source such as the shore power source 142. The power from the shore power source 142 may be 480 VAC three phase power. In other forms, the shore power has different voltage and phases, for example, the shore power may be 208 VAC, 240 VAC, or 120 VAC single phase or three-phase power. The electrical input 152 may include an interface for releasably connecting the electrical input 152 with the shore power source 142. The electrical input 152 may include an electrical connector 153 that is connected to an electrical connector 143 of the shore power source 142. The electrical connectors 143, 153 include electrical conductors, such as a cord or wires. The electrical connector 153 may be an electrical cord and/or plug that may extend from the switch 144 and be plugged into an electrical socket of the electrical connector 143 of the shore power source 142. In some forms, the electrical connector 153 of the electrical input 152 includes an electrical socket for receiving an electrical plug of the connector 143 of the shore power source 142, such as a standard plug of current 480 VAC shore power source infrastructure or a high voltage connector. The electrical input 152 may be connected to the shore power source 142 when the semi-truck 100 is at a truck stop, dock, or other place having an accessible shore power source 142. The electrical input 152 may be disconnected from the shore power source 142, for example, when the semi-truck 100 is to be driven to another location.

The switch 144 may include a sensor at the electrical input 152 to determine whether the electrical input 152 is connected to the shore power source 142. As one example, the sensor includes proximity switch 146 that may be attached to the electrical input 152 to detect whether the electrical connector 153 is connected to the shore power source 142. For example, where the electrical connector 143 includes an electrical socket, the proximity switch 146 may determine whether an electrical plug of the shore power source 142 is received within the electrical socket. As another example, where the electrical connector 143 includes an electrical plug, the proximity switch 146 may determine whether the electrical plug of the electrical input 152 is inserted into a corresponding electrical socket of the shore power source 142. The switch 144 may communicate data from the proximity switch 146 to a computing device or controller. For instance, the switch 144 may communicate data from the proximity switch 146 to the electronic control unit 120. The electronic control unit 120 may adjust the configuration of the switch 144 based on whether the electrical connector 143 is connected to the shore power source 142. For example, where the refrigeration unit 127 is running (e.g., the motor 178 is operating), the electronic control unit 120 may change the configuration of the switch 144 to power the refrigeration unit 127 from the shore power source 142 to conserve the power of the battery 130. The electronic control unit 120 may also adjust the configuration of the switch 144 to charge the battery 130 from the shore power source 142.

The electrical output 154 is connected to the refrigeration unit 127. The refrigeration unit 127 may cool an interior space or compartment (e.g., a cargo box) of a trailer, van, box truck, etc. to keep the temperature within the interior compartment below a predetermined temperature, at a predetermined temperature, or within a certain temperature range. The refrigeration unit 127 may include or communicate with a temperature sensor to determine the temperature of the interior compartment. The refrigeration unit 127 includes a motor 178 for running a compressor of the refrigeration unit 127. The refrigeration unit 127 may also include a condenser 177, expansion valve 179, and evaporator 181. The compressor may be run to compress refrigerant gas causing the gas to heat up as it is pressurized. The pressurized refrigerant gas flows through coils of the condenser 177 and dissipates heat. The refrigerant gas flows through the expansion valve 179 into the evaporator 181 where the temperature of the gas drops significantly as the gas vaporizes. The gas flows through coils of the evaporator 181 within the interior compartment that is being cooled. The gas within the evaporator 181 absorbs heat within the interior compartment and cools the interior compartment. The gas flows through the evaporator and returns to the compressor where the process is repeated.

The refrigeration unit 127 may draw current from the electrical output 154 upon determining to operate the motor 178 to cool the interior compartment to maintain the desired temperature of the interior compartment. The refrigeration unit 127 may include a battery 185 (e.g., a low voltage battery) such that the refrigeration unit 127 is able to remain on even when disconnected from the shore power source 142 and battery 130. For example, the refrigeration unit 127 may continue to monitor the temperature of the interior compartment even when the motor 178 is not drawing power from the battery 130 or shore power 142 and determine when to operate the motor 178 to provide cooling. The battery 185 may have a smaller capacity than the battery 130 (e.g., the high voltage battery 130A), because the power required to determine when to operate the motor 178 to cool the interior compartment of the vehicle is less than the power required to operate the motor 178 to cool the interior compartment.

The refrigeration unit 127 may optionally include an electric generator 183, such as a diesel-powered generator, for generating electrical power to run the refrigeration unit 127, e.g., to operate the motor 178 and/or charge the battery 185. The generator 183 may be run when the electrical input 152 is not connected to a shore power source 142 and when the battery 130 is not able to provide enough power to operate the refrigeration unit 127 (e.g., the battery 130 charge level is low or below a threshold). The generator 183 may be used to generate electrical power to run the refrigeration unit 127 and may also be used to charge the battery 130 as described below.

The electrical output 154 includes a connector 155 for electrically connecting the electrical output 154 to a connector 158 of the refrigeration unit 127. The connectors 155, 158 may be standard TRU connectors used with existing electrically powered TRUs for connecting the TRU directly to a shore power source. The connectors 155, 158 include electrical conductors, such as a cord or wires. The connector 158 of the refrigeration unit 127 may include an electrical cord and/or plug that extends from the refrigeration unit 127 to plug into a socket of the connector 155 of the electrical output 154. In some forms, the connector 155 of the electrical output 154 includes the electrical cord and plug for connecting with a socket of the connector 158 of the refrigeration unit 127. In some forms, the refrigeration unit 127 is permanently wired to the electrical output 154.

The power conditioning interface 156 of the switch 144 may also include a connector 166 for electrically connecting the switch 144 to the power conditioning circuitry 150. The connector 166 may include electrical conductors, such as a cord or wires. In other forms, the switch 144 may be integrated into the power conditioning circuitry 150 with the power conditioning interface 156 connected through a circuit board, bus bars, or wires as some examples.

Regarding FIG. 3B, the switch 144 includes a set of input contactors 170 associated with the electrical input 152, a set of output contactors 172 associated with the electrical output 154, and a set of power conditioning contactors 174 associated with the power conditioning interface 156. The switch 144 is configured to handle three-phase power with each set of contactors 170, 172, 174 having three contactors corresponding to each line of the three-phase power. In an embodiment wherein the switch 144 is configured to utilize single-phase power, a single contactor may be used for each of the input contactor 170, output contactor 172, and power conditioning contactor 174. In other forms where the switch is configured to utilize single-phase power, a set of two contactors may be used for each of the input contactor 170, output contactor 172, and power conditioning contactor 174, with a contactor on both the line and neutral conductors. The switch 144 includes a relay 171 for opening and closing the input contactors 170, a relay 173 for opening and closing the output contactors 172, and a relay 175 for opening and closing the power conditioning contactors 174. The relays 171, 173, 175 may be integrated into the respective contactors 170, 172, 174 or may be separate components connected to the contactors 170, 172, 174. A conductor bus 176 electrically connects each of the input contactors 170 to corresponding contactors of the output contactors 172 and power conditioning contactors 174. Thus, the relays 171, 173, 175 may be used to open or close the contactors 170, 172, 174 to selectively connect the electrical input 152, electrical output 154, and the power conditioning interface 156 to one another. The contactors 170, 172, 174 may be electromechanical contactors or solid-state contactors, although other switching control mechanisms may be used for the contactors 170, 172, 174 to selectively permit electrical current to flow to or inhibit electrical current flowing from the conductors of the electrical input 152, electrical output 154, and/or power conditioning interface 156.

In some forms, the power conditioning contactors 174 may alternatively be included in the power conditioning circuitry 150 rather than in the switch 144. The refrigeration unit 127 may include a computing device that determines when to operate the motor 178 and draw electrical power from the switch 144. In forms where the switch 144 includes output contactors 172, the refrigeration unit 127 may be able to communicate with the electronic control unit 120 and/or the power system 140 to cause the switch 144 to close the output contactors 172 when the refrigeration unit 127 determines to operate the motor 178. In some forms, the power system 140 does not include the power conditioning contactors 174 and instead the power conditioning circuit 150 (e.g., inverter switches 188 of a power inverter 182) is used to selectively permit current to flow between the switch 144 and the battery 130. In some forms, the switch 144 does not include output contactors 172 and the conductor bus 176 of the switch 144 is permanently electrically connected to the refrigeration unit 127.

The switch 144 may also include the current sensor 148 for determining the amount of current flowing from the switch 144 to the refrigeration unit 127. The current determined to flow to the refrigeration unit 127 may be used to calculate the power drawn by the refrigeration unit 127 and/or to calculate the power available for the battery 130. For example, the refrigeration unit 127 may operate at a known voltage and the power draw of the refrigerator 127 may be calculated using known voltage and the current detected by the current sensor 148. The amount of power drawn by the refrigeration unit 127 may be used to determine whether the refrigeration unit is on, running, and what percentage of the power capacity of the shore power 142 is being consumed by the refrigeration unit 127. The switch 144 may communicate data from the current sensor 148 to a computing device or controller. For instance, the switch 144 may communicate data from the current sensor 148 to the electronic control unit 120 for use and analysis.

Regarding FIG. 3A, the power conditioning circuitry 150 includes a power transformer 180 and power inverter 182. The power conditioning circuitry 150 is a bidirectional power converter, such that the power conditioning circuitry 150 is able to convert the DC power from the battery 130 to AC power usable by the refrigeration unit 127 when the power system 140 is in a first mode. The power conditioning circuitry 150 is able to convert the AC power from the shore power source 142 to DC power to charge the battery 130 when the power system 140 is in a second mode.

In the form shown, the power transformer 180 includes a transformer 184 in a three phase, delta-star configuration and three LC filters 186 corresponding to each line of the three-phase power. The LC filters are low-pass filters that permit low frequencies (e.g., AC line frequencies) to pass through while filtering out undesired high frequency harmonics of the voltage and current waveforms. Each LC filter 186 may include an inductor 186A and a capacitor 186B to convert a square wave to a sine wave when converting from DC to AC power and AC to DC power. The LC filter 186 may operate to smooth the AC voltage and current waveform by filtering out the ripples in the waveform when converting from DC to AC power to provide an electrical power having a smooth sine waveform to the refrigeration unit 127. The power inverter 182 includes six inverter switches 188 forming a three-phase H bridge inverter circuit. Each inverter switch 188 includes a transistor switch 188A and an antiparallel diode 188B. While a three-phase H bridge inverter circuit is provided, those having skill in the art will readily appreciate that other inverter circuits may be used to bidirectionally convert between AC power and DC power. The power system 140 may regulate the amount of power flowing to the battery 130 from the switch 144 using the power inverter 164 by controlling the bias to the inverter switches 188. For example, the power system 140 may limit the amount of power flowing to the battery 130 when the battery 130 is not able to handle all of the power from the switch 144, for example, when the battery 130 is approaching full charge or the temperature of the battery 130 is high.

The power transformer 180 may also include other circuit elements such as isolation transformers. The isolation transformer may be a 1:1 transformer that is positioned between the battery 130 and the switch 144. For example, the isolation transformer may be positioned between the power transformer 180 and power inverter 182. The isolation transformer may attenuate noise and voltage surges flowing to and from the battery 130.

When charging the battery 130 from the shore power source 142, the transformer 184 changes the voltage of each phase of the three-phase AC power received via the switch 144 from shore power 142. As one example, the power transformer 180 may step down the voltage of the power received from the shore power 142 to a voltage level appropriate to charge the high voltage battery 130A (e.g., 240-260 VAC). The transformer 184 may include primary and secondary windings which have a winding ratio that steps down the voltage of the power received from the shore power source to the desired voltage level. The current may flow through the LC filter 186 to filter out undesired high-frequency harmonics. The current may flow through the inverter switches 188 to charge the high voltage battery 130A.

When powering the refrigeration unit 127 from the battery 130 with the electric power system 140 of FIG. 3A, current may flow from the battery 130 through the power inverter 182 and the power transformer 180 to the switch 144. A controller (e.g., the electronic control unit 120) may control the transistors 188A of the inverter switches 188 to output power having a square voltage waveform. The square voltage waveform is converted to a sinusoidal voltage waveform as it passes through the LC filter 186. The power flows from the LC filter 186 to the transformer 184 which transforms the voltage to the desired voltage to run the refrigeration unit 127 (e.g., 480 VAC), for example, the transformer 184 may step up the voltage. Thus, the power conditioning circuitry 150 may be used bidirectionally to convert the battery 130 DC power to AC power or to convert AC power to DC power to charge the battery 130, depending on the mode of operation of the power conditioning circuitry 150. The electronic components of the power conditioning circuit 150 of FIG. 3A are given by way of example and it should be understood that the power conditioning circuit 150 may take other forms known in the art to convert power from DC power to AC power to power an electrically powered device (e.g., the refrigeration unit 127) and/or to convert AC power to DC power to charge the battery 130.

The power system 140 inhibits power from back feeding to the shore power source 142 from the battery 130 by way of the power inverter 182 of the power conditioning circuit 150 that regulates the flow of power from the shore power source 142 to the battery 130. The power inverter 182 may also have an anti-islanding protection function which prevents power from being provided to the shore power source 142 from the battery 130. The switch 144 may also be used to inhibit back feeding of electrical power into the shore power source 142, for example, when the refrigeration unit 127 is powered by the battery 130 by opening the input contactors 170 (see FIG. 3B).

The battery 130 may be connected to the power conditioning circuitry 150 by a battery interface 131. The battery interface 131 may include an electrical connector, such as conductors or wires, connected to terminals or electrical contacts of the battery 130 and the power system 140. In one embodiment, the battery interface 131 includes battery cables having terminal connectors configured to be secured to posts of the battery 130. Other embodiments include metal busbars and flat cable.

The power system 140 may be connected to the high voltage battery 130A via the battery interface 131 and the low voltage battery 130B is charged from the high voltage battery 130A. A battery charger 230 may include a switch, a processor to implement battery charging logic, and a power transformer to convert the power of the high voltage battery 130A to a power level appropriate to charge the low voltage battery 130B. For example, where the high voltage battery 130A is a 400 VDC battery and the low voltage battery 130A is a 12 VDC battery, the battery charger 230 may transform the 400 VDC power to 12 VDC power. The high voltage battery 130A may be used to charge the low voltage battery 130B. The battery 130B powers the electronic control unit of the power circuit 140 to ensure that the control unit of the power system 140 has power to control the power system 140 (e.g., the state of the contactors 170, 172, 174 and inverter switches 188). In other forms, the power system 140 may be connected directly to the low voltage battery 130B via the battery interface 131 and configured to condition the power received from the shore power source 142 to a voltage and/or current appropriate to charge the low voltage battery 130B. For example, the battery interface 131 may transform 400 VDC power output by the power inverter 182 to 12 VDC to charge the low voltage battery 130B. The power system 140 may thus be configured to output power at varying voltages to charge the high voltage battery 130A and the low voltage battery 130B.

The switch 144 may be controlled by an electronic control unit, for example, the electronic control unit 120, to change the state of the contactors 170, 172, 174 to control the electrical connection between the electrical input 152, the electrical output 154, and the power conditioning interface 156. For example, the switch 144 may receive a control signal from the electronic control unit 120 to open one or more sets of contactors and close other contactors. Upon receiving the control signal, the relays 171, 173, 175 of the switch 144 corresponding to the contactors 170, 172, 174 may be energized or de-energized to open or close each set of contactors 170, 172, 174.

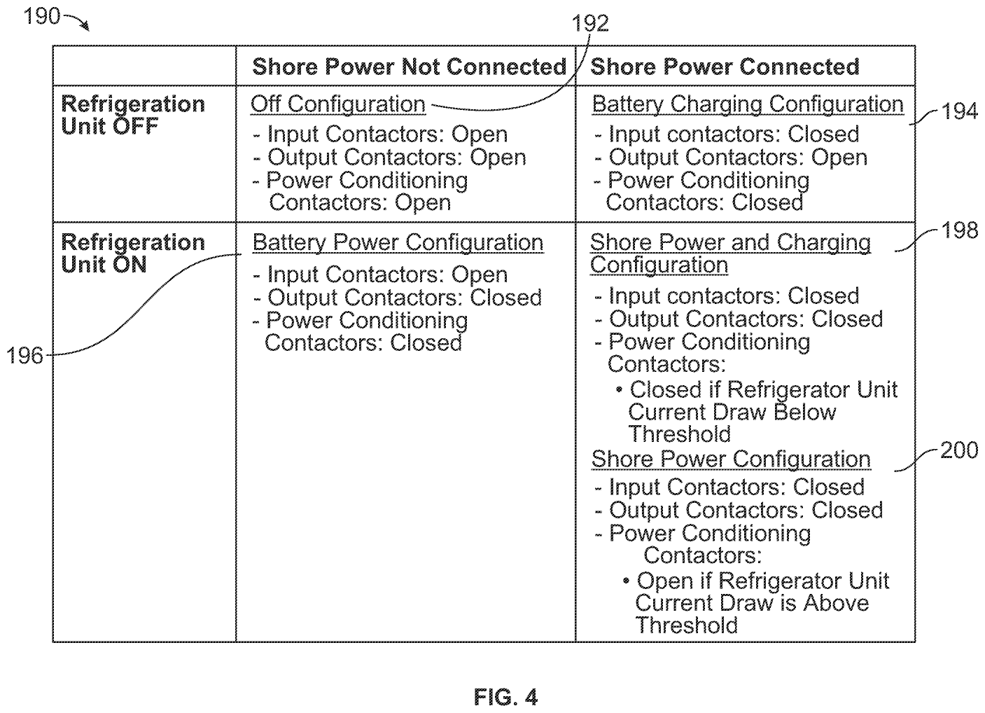

In one approach, with reference to FIG. 4, a table 190 is provided showing configurations of the switch 144. The electronic control unit 120 or other control unit may determine the configuration of the switch 144 based on one or more vehicle parameters, such as whether the proximity switch 146 indicates the electrical input 152 is connected to shore power 142 and based on the amount of current the current sensor 148 detects is flowing to the refrigeration unit 127. In some forms, the electronic control unit 120 and/or the power system 140 may communicate with the refrigeration unit 127 to determine whether the refrigeration unit 127 is requesting power and/or to determine how much power the refrigeration unit 127 needs. The following discussion relates to the power system 140 of FIG. 3A where the switch 144 includes input contactors 170, output contactors 172, and power conditioning contactors 174. It will be appreciated that modifications to the following discussion may be made for embodiments where the switch 144 does not include the input contactors 170, output contactors 172, and/or power conditioning contactors 174.

The switch 144 may be set to an off configuration 192 to prevent power from flowing through the switch 144. The switch 144 may be set to the off configuration 192 when the proximity switch 146 indicates that the switch 144 is not connected to the shore power source 142 and the refrigeration unit 127 is off or not running. The electronic control unit 120 may determine whether the refrigeration unit 127 is on or off (e.g., the motor 178 is not operating) based on communication with the refrigeration unit 127. For example, the electronic control unit 120 may receive a run request from the refrigeration unit 127 when the refrigeration unit 127 is to be powered to operate the motor 178. Where the electronic control unit 120 does not receive a run request from the refrigeration unit 127, the electronic control unit 120 may determine the refrigeration unit 127 is off. In the off configuration 192, each of the input contactors 170, output contactors 172, and power conditioning contactors 174 are open so that current is not able to flow through the switch 144.

The switch 144 may be set to a battery charging configuration 194 to charge the battery 130 from the shore power source 142. The switch may be set to the battery charging configuration 194 when the proximity switch 146 indicates that the electrical input 152 of the switch 144 is connected to the shore power source 142 and the refrigeration unit 127 is off and/or not drawing current from the switch 144 (e.g., the motor 178 is not operating). In the battery charging configuration, the output contactors 172 are open and the input contactors 170 and power conditioning contactors 174 are closed. Current flows from the shore power source 142 through the input contactors 170, the conductor bus 176, and power conditioning contactors 174, if present, to the power conditioning circuit 150 to charge the battery 130 as described above. In some forms, the electronic control unit 120 further monitors the charge level of the battery 130 and when the charge level of the battery is full or exceeds a predetermined threshold, sets the switch 144 to the off configuration 192.

The switch 144 may be set to a battery power configuration 196 to power the refrigeration unit 127 with the battery 130. The switch 144 may be set to the battery power configuration 196 when the proximity switch 146 indicates that the switch 144 is not connected to the shore power source 142 and the electronic control unit 120 received a run request from the refrigeration unit 127. In the battery power configuration, the input contactors 170 are open and the output contactors 172 and power conditioning contactors 174 are closed. In the battery power configuration 196, the refrigeration unit 127 draws power from the battery 130 to run the refrigeration unit 127. Current flows from the battery 130 through the power conditioning circuit 150, through the power conditioning contactors 174, conductor bus 176 and output contactors 172 of the switch 144 to the refrigeration unit 127. The battery power configuration 196 may be used when the vehicle is in transit and/or disconnected from the shore power source 142 to power the refrigeration unit 127 with power stored in the battery 130.

The switch 144 may be set to a shore power and charging configuration 198 to power the refrigeration unit 127 and charge the battery 130. The switch 144 may be set to the shore power and charging configuration 198 when the proximity switch 146 indicates that the switch 144 is connected to the shore power source 142, the electronic control unit 120 received a run request from the refrigeration unit 127, and the current sensor 148 indicates the refrigeration unit 127 is drawing less than a predetermined amount of current. For example, the predetermined amount of current may be a percentage of the maximum available current from the shore power source 142, e.g., 60-70%. By monitoring the amount of current drawn by the refrigeration unit 127, the power system 140 ensures the refrigeration unit 127 is able to draw enough current to maintain the temperature of the enclosed space or compartment without drawing more power from the shore power source 142 than the shore power source 142 is rated for. Alternatively or additionally, the amount of power consumed by the refrigeration unit 127 may be monitored. The amount of power consumed by the refrigeration unit 127 may be calculated based on the current draw of the refrigeration unit 127 and the voltage of the shore power source 142. The switch 144 may be set to the shore power and charging configuration 198 when the refrigeration unit 127 is consuming less than a predetermined amount of power, such as less than 60-70% of the maximum available power from the shore power source 142. Where the refrigeration unit 127 is drawing less than the predetermined threshold amount of current and/or power from the shore power source 142, the switch 144 is in the shore power and charging configuration with the input contactors 170, output contactors 172, and power conditioning contactors 174 closed. The battery 130 is charged by the shore power source 142 while the refrigeration unit 127 is also powered by the shore power source 142.

The switch 144 may be set to a shore power configuration 200 to power the refrigeration unit 127 from the shore power source 142 and not charge the battery 130. The switch 144 may be set to the shore power configuration 200 where the proximity switch 146 indicates that the switch 144 is connected to the shore power source 142, the electronic control unit 120 received a run request from the refrigeration unit 127, and the current sensor 148 detects the refrigeration unit 127 is drawing more than a predetermined amount of current and/or where the high voltage battery 130 is unable to accept a charge. For example, the predetermined amount of current may be a percentage of the maximum available current from the shore power source 142, e.g., 60-70%. Upon the current draw of the refrigeration unit 127 exceeding the predetermined threshold, the switch 144 may be set to provide power to the refrigeration unit 127 and not charge the battery 130 to ensure the refrigeration unit 127 receives enough power to cool the enclosed space or compartment. As another example, where the current draw of the refrigeration unit 127 is below the threshold and the battery 130 is fully charged and/or in a state where the battery 130 is not able to accept a charge, the switch 144 may be set to the shore power configuration 200 to provide power to the refrigeration unit 127 and not charge the battery 130. In the shore power configuration 200, the switch 144 is set such that the input contactors 170 and output contactors 172 are closed and the power conditioning contactors 174 are open. When the current draw of the refrigeration unit 127 falls below the predetermined threshold, the switch 144 may be set to the shore power and charging configuration 198 and close the power conditioning contactors 174 to charge the battery 130. The switch 144 may also be set to the shore power configuration 200 upon a determination that the battery 130 is fully charged or the temperature of the battery 130 has exceeded a predetermined threshold.

In forms where the refrigeration unit 127 includes the generator 183, the switch 144 may be set to a generator charging configuration to use the generator 183 to charge the battery 130. The switch 144 may be set to the generator charging configuration when the proximity switch 146 indicates that the switch 144 is not connected to the shore power source 142, the refrigeration unit 127 is on and/or the motor 178 is operating, and the charge level of the battery 130 is below a predetermined threshold such that the battery 130 is able to be charged. A control unit, such as the electronic control unit 120, may communicate with the refrigeration unit 127 via communication circuitry 128 to determine when the motor 178 is operating and when the generator 183 is running. The electronic control unit 120 may also communicate with the battery 130 to determine a charge level of the battery 130. In the generator charging configuration, the switch 144 is set to a configuration similar to the battery power configuration, with the input contactors 170 open and the output contactors 172 and power conditioning contactors 174 closed. In the generator charging configuration, current flows from the generator 183 of the refrigeration unit 127, through the electrical output 154, conductor bus 176, power conditioning contactors 174, and through the power conditioning circuit 150 to the battery 130. The generator charging configuration may be used when the vehicle is in transit and/or disconnected from the shore power source 142 to power the refrigeration unit 127 and charge the battery 130.

The electronic control unit 120 may determine to charge the battery 130 with the generator 183 when the generator 183 is running and the electronic control unit 120 determines that a variable of the generator 183, such as efficiency, may be improved by charging the battery 130. For example, the control unit 120 may monitor the operation of the generator 183 and calculate an operating efficiency of the generator 183 in converting fuel to electrical power. A generator of a refrigerator unit is typically most efficient when the generator is operating at 80% to 90% of its maximum capacity. The memory 124 of the electronic control unit 120 may store optimal operating conditions of the generator (e.g., a motor speed, operating capacity) where the generator 183 operates with a maximum efficiency in converting fuel (e.g., diesel) to electrical power. The control unit 120 may compare the calculated operating efficiency of the generator 183 with the optimal operating conditions and determine whether the efficiency of the generator 183 could be improved. For example, where the generator 183 is powering the refrigeration unit 127, the electronic control unit 120 may determine whether providing electrical power to the battery 130 in addition to the refrigeration unit 127 would improve the operation of the generator. The electronic control unit 120 may compare the efficiency of the generator 183 when powering the refrigeration unit 127 with the efficiency of the generator when powering both the refrigeration unit 127 and battery 130, e.g., operating at a higher capacity. If the efficiency of the generator 183 when powering both the refrigeration unit and the battery 130 is higher, the electronic control unit 120 may set the switch 144 to the generator charging configuration and increase the power generated by the generator 183 to increase the efficiency of the generator 183. As another example, if the generator 183 is powering the refrigeration unit 127 and the electronic control unit 120 determines that increasing the power output of the generator 183 beyond what the refrigeration unit 127 is consuming would improve the efficiency of the generator 183, the control unit 120 may set the switch 144 to the generator charging configuration to electrically connect the battery 130 to the generator 183 to also charge the battery 130. Improving the efficiency of the generator 183 enables the fuel consumed by the generator 183 to be efficiently converted electrical power. The electrical power generated beyond what the refrigeration unit 127 consumes that is received from the generator 183 and stored in the battery 130 may later be used to power the refrigeration unit 127 as described above.

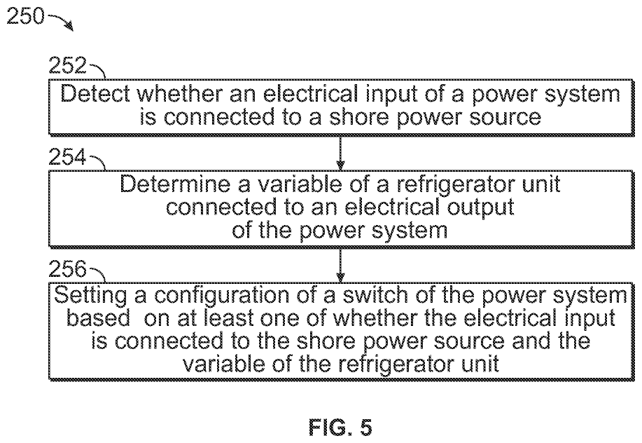

With respect to FIG. 5, a method 250 of operating the power system 140 is provided. A control unit may detect 252 whether the electrical input 152 of the switch 144 of the power system 140 is connected to the shore power source 142. The control unit may be the electronic control unit 120, may communicate with the electronic control unit 120, or may be a control unit of the power system 140 as some examples. The control unit of the power system 140 may determine whether the electrical input 152 is connected to the shore power source 142 based on data received from a sensor, such as the proximity switch 146. Where the proximity switch 146 indicates the electrical input 152 is coupled to a connector 143 of the shore power source 142, the control unit may determine that the electrical input 152 is connected to or plugged into the shore power source 142.

The control unit of the power system 140 may determine 254 a variable of the refrigeration unit 127. For example, the control unit 120 may determine whether the refrigeration unit 127 is sending a run request, is in a standby mode (and is not sending a run request), is in a run mode, is drawing current, and/or how much current is being drawn (e.g., the operating capacity of the refrigeration unit 127). The control unit 120 may determine the variable of the refrigeration unit 127 based on a communication from the refrigeration unit 127. For example, the control unit may receive a run request from the refrigeration unit 127 that includes how much power the refrigeration unit 127 needs to operate. Additionally or alternatively, the control unit 120 may determine the variable of the refrigeration unit 127 based on data received from the current sensor 148 of the switch 144 of the power system 140. For example, where the current sensor 148 detects that the refrigeration unit 127 is drawing no current, the control unit 120 may determine that the refrigeration unit 127 is not running. For instance, where the switch 144 is in the battery power configuration 196, shore power and charging configuration 198, or shore power configuration 200, the control unit may monitor the current draw of the refrigeration unit 127 and determine the refrigeration unit 127 has stopped running when the current draw of the refrigeration unit 127 drops, for example, to about zero amps. Where the current sensor 148 detects that the refrigeration unit 127 is drawing current beyond a threshold value, the current sensor 148 may determine that the refrigeration unit 127 is running. The control unit 120 may determine the amount of current drawn or power being consumed by the refrigeration unit 127 and determine whether the current draw/power consumption exceeds a predetermined threshold. The predetermined threshold may be a percentage of the available current or power from the shore power source 142 as described above.

The control unit may set 256 the configuration of the switch 144 of the power system 140 based at least in part on whether the electrical input is connected to the shore power source 142 and/or on the variable of the refrigeration unit 127. The control unit may select the configuration of the switch 144 based on whether the switch 144 is connected to the shore power source 142 and whether the refrigeration unit 127 is on and/or how much current the refrigeration unit 127 is drawing. For example, the control unit may select the configuration of the switch 144 as described above with regard to FIG. 4. For example, where the shore power source 142 is not connected and the refrigeration unit 127 is not running, the control unit may select to set the switch to the off configuration 192. Where the shore power source 142 is connected and the refrigeration unit 127 is not running, the control unit may select to set the switch to the battery charging configuration 194. Where the shore power source 142 is not connected and the refrigeration unit 127 is running, the control unit may select to set the switch to the battery power configuration 196. Where the shore power source 142 is not connected, the refrigeration unit 127 is running, and the battery 130 charge level is low, the control unit may run the generator 183 and may select to set the switch to the generator charging configuration. Where the shore power source 142 is connected and the refrigeration unit 127 is running, the control unit may select to set the switch to the shore power and charging or shore power configurations 198, 200 based on the amount of current/power being drawn by the refrigeration unit 127. Upon selecting the configuration of the switch 144, the control unit may send a control signal to the switch 144 to cause the switch 144 to be set to the desired configuration. The control signal may cause the relays 171, 173, 173 to be energized or de-energized or open or close each of the contactors 170, 172, 174 to place the switch 144 in the desired configuration.

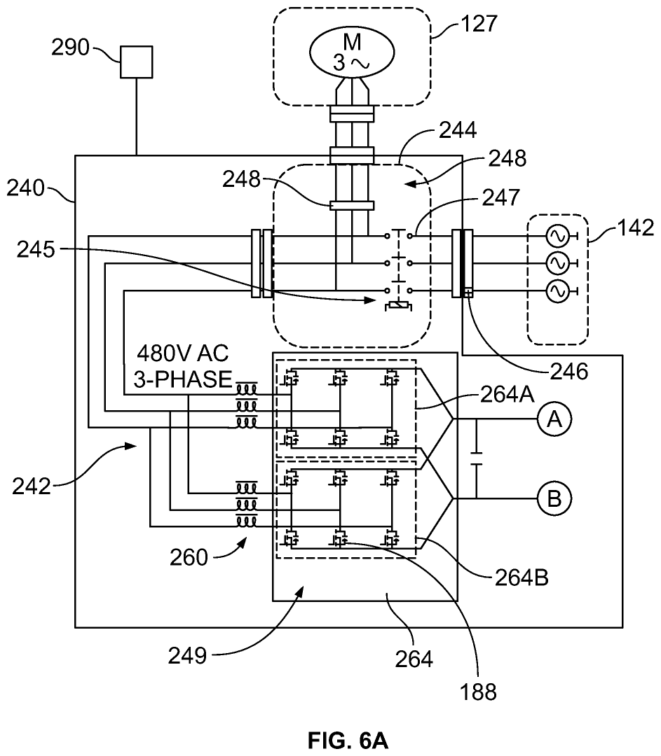

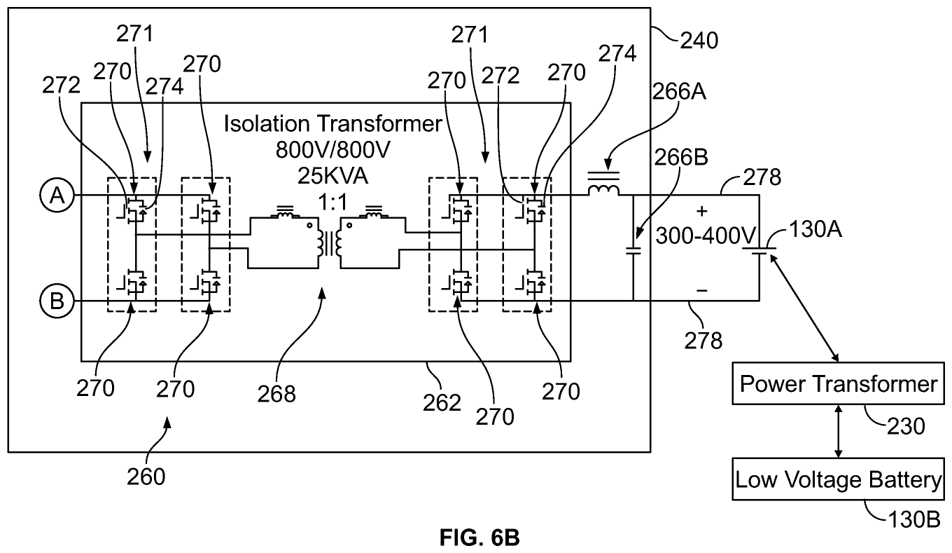

With respect to FIGS. 6A-6B, a power system 240 is shown according to an alternative embodiment. The power system 240 is similar in many respects to the power system 140 described above such that the differences will be highlighted in the following discussion. For example, the power system 240 includes a power conditioning circuit 260 operable to convert DC power of the battery 130 to AC power to run the refrigeration unit 127 or to convert AC power to DC power to charge the battery 130. One difference between the power systems 140, 240 is the configuration of the power conditioning circuit 260. In particular, the arrangement of the power transformer and the power inverter of the power system 240 is reversed compared to the power system 140 provided above.

The power system 240 includes a switch 242 that is operable to reconfigure the power system 240 between the various configurations discussed above with respect to FIG. 4. The switch 242 includes a switch portion 244 and a switch portion 249. The switch portion 244 includes input contactors 247, a relay 245 operable to open and close the input contactors 247, a proximity switch 246, and a current sensor 248. The switch portion 249 includes the power conditioning circuit 260 or a portion thereof. The switch portion 249 controls current flow to and from the switch portion 244.

Regarding FIGS. 6A and 6B, the power conditioning circuit 260 includes a power transformer 262 and a power inverter 264. The power transformer 262 is a DC-to-DC power converter. When powering the refrigeration unit 127 from the battery 130A, current flows from the battery 130A to the power transformer 262, then through the power inverter 264, and through the switch portion 244 to the refrigeration unit 127. When charging the battery 130 from the shore power source 142, current flows through the switch portion 244, to the power inverter 264, then through the power transformer 262 to the battery 130A. The power inverter 264 includes two power inverter circuits 264A, 264B in parallel with one another. Each power inverter circuit 264A, 264B is similar to the power inverter 182 described above including six inverter switches188 forming a three-phase H-bridge inverter circuit. Two or more power inverter circuits 264A, 264B may be used in parallel to meet the power specifications of the system, for example, to pass a desired amount of power through the power inverter 264 to power the refrigeration unit 127 and other onboard devices 126 from the battery 130.

The power transformer 262 is a bidirectional DC-DC power converter circuit configured to step down the voltage of the power received from the power inverter 264 to a desired voltage to charge the battery 130A and to step up the voltage of the power from the battery 130A to a voltage usable to power the refrigeration unit 127. In another embodiment, the power transformer 262 may be used to step up the voltage of the power from the power inverter 264 to a voltage to charge the battery 130A and to step down the voltage of the power from the battery 130A to a voltage usable to power the refrigeration unit 127. The power transformer 262 may include DC choke 266A and DC capacitor 266B to smooth the waveform as current flows to and from the battery 130A by filtering out ripples from DC current and DC voltage, respectively.

The power transformer 262 is a DC-to-DC converter in the embodiment of FIG. 6B. The power transformer 262 is a galvanically isolated bridge converter that uses a dual full bridge converter arrangement. The power transformer 262 includes two full bridge converters 271 separated by an isolation transformer 268. Each bridge converter 271 of the power transformer 262 includes four switching devices 270 arranged in a full-bridge topology that each include a transistor 272 with an anti-parallel diode 274. The transistors 272 may be a MOSFET, wide bandgap semiconductor, IGBT, or bipolar transistors as examples. An electronic control unit 290 of the power system 240 controls the duty cycle to the transistors 272 with the target voltage and target current value provided by the battery management system to regulate the voltage of the power flowing through the power transformer 262. The isolation transformer 286 includes a primary winding and secondary winding that are separated by an air gap. The isolation transformer 268 may have, as examples, a 1:1 or 2:1 turns ratio. The isolation transformer 268 provides galvanic isolation to inhibit surge and grounding problems. While a dual full bridge converter is shown and described, other DC-to-DC converter configurations may be used to step up or step down power flowing to or from the battery 130. In another other embodiment, the isolation transformer 268 may be positioned between the switch 244 and power inverter 264 or between the power transformer 262 and power inverter 264.

The proximity switch 246 and current sensor 248 of the switch portion 244 operate in a manner similar to the proximity switch 146 and the current sensor 148 discussed above to determine when the electrical input of the power system 240 is connected to the shore power source 142 and the power consumed by the refrigeration unit 127. In one embodiment, the switch portion 244 does not include output contactors or power conditioning contactors as in the switch 144 of FIG. 3B. The electronic control unit 290 of the power system 240 may operate the power inverter 264 and/or power transformer 262 as part of the switch 242 to control the flow of power to and from a battery interface 278 to which the battery 130 is connected. For instance, the power system 240 may configure the power inverter 264 to prevent current from flowing through the power inverter 264 or to permit current to flow through the power inverter 264. With the electronic control unit 290 configuring the power inverter 264 to permit current flow through the power inverter 264, the electronic control unit 290 may operate the power inverter 264 to regulate current flow in either direction, i.e., from the transformer 262 or to the transformer 262. The electronic control unit 290 may regulate current flow through the power inverter 264 by operating the inverter switches 188. As another example, the power system 240 may additionally or alternatively configure the power transformer 262 to prevent current from flowing through the power transformer 262 or to permit current to flow through the power transformer 262, for example, by operating the switching devices 270.

The electronic control unit 290 may be a control unit of the vehicle 100 such as electronic control unit 120, or may be a separate control unit of the power system 240 such as in communication with the electronic control unit 120. The electronic control unit 290 may include a processor and memory. The processor may include, for example, a microprocessor, an application-specific integrated circuit (ASIC), and/or a system-on-a-chip. The memory may include, for example, read-only memory (ROM), random access memory (RAM) such as DRAM and SRAM, and/or flash memory. The processor and memory may be provided on a circuit board. The electronic control unit 290 unit may also include communication circuitry for communicating with other devices, such as the electronic control unit 120, motor controller 116, battery 130, thermal management unit, high voltage power distribution unit, isolation monitoring unit, telematics, safety circuits, display, state of charge display, service port and/or power system 240, via wired and/or wireless connections. As examples, the communication circuitry may be configured to communicate using one or more of a controller area network (CAN), wireless fidelity (Wi-Fi), cellular, radio frequency (RF), infrared (IR), Bluetooth (BT), Bluetooth Low Energy (BLE), Zigbee and near field communication (NFC). In some embodiments, the communication circuitry is configured to communicate with a remote computer via a wide area wireless network and the internet.

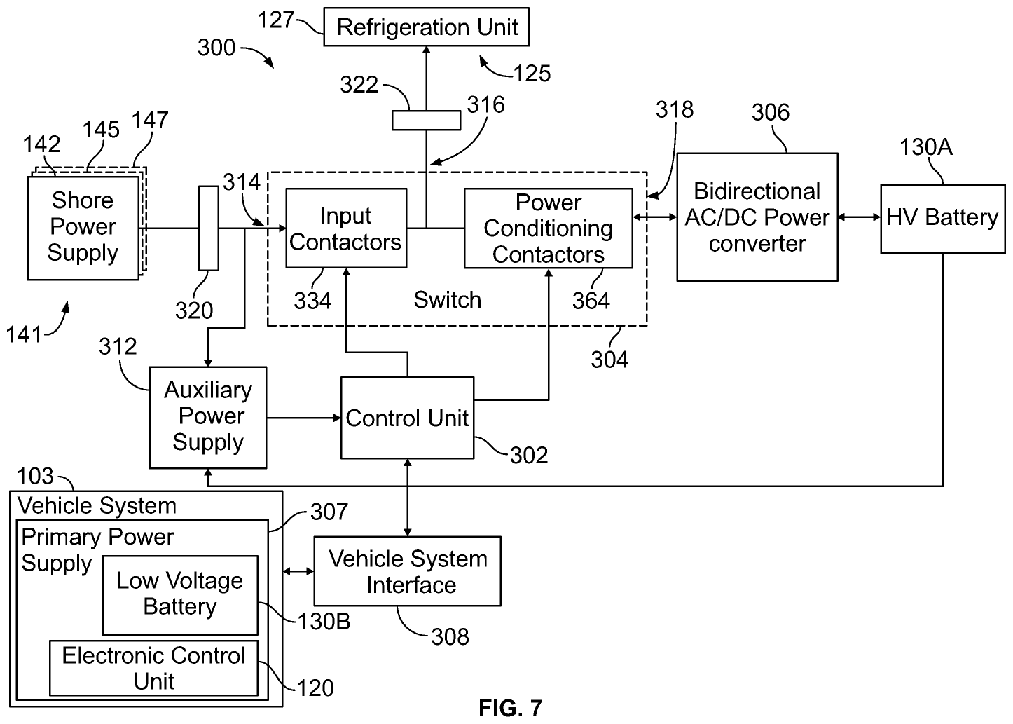

With respect to FIG. 7, a power system 300 is shown according to another embodiment. The power system 300 is similar in many respects to the power system embodiments discussed above such that the differences will be highlighted in the following discussion. The power system 300 includes a control unit 302 that controls the configuration of the switch 304 to permit electrical power to flow from an external power source 141 to the high voltage battery 130A and/or an electrically powered device 125 of the vehicle 100, such as the refrigeration unit 127. The control unit 302 further controls the configuration of the switch 304 to permit electrical power to flow from the high voltage battery 130A to the electrically powered device 125, e.g., refrigeration unit 127.

Similar to the embodiments discussed above, the switch 304 includes an electrical input 314, electrical output 316, and power conditioning interface 318. The electrical input 314 may be releasably or permanently connected to the external power source with one or more connectors 320. The external power source 141 may include the shore power source 142, a second shore power source 145, and/or an electrical power generator system 147 of the vehicle 100. The electrical input 314 may include two or more connectors 320 to connect to one or multiple of the power sources. For instance, the connectors 320 may be mounted at different areas of the vehicle to permit a user to connect the electrical input 314 to the desired shore power source 142, 145 with the connector 320 that is more convenient, for example, the connector 320 closer to the outlet plug of the shore power source 142, 145. The electrical power generating system 147 may include, as examples, a heat recovery system such as an engine exhaust energy harvesting system, a dynamic energy-harvesting system such as a shock absorber system, solar power system of the vehicle including one or more solar panels and a solar inverter, a wind turbine system, an external three-phase inverter with a battery, an external three-phase inverter with ultracapacitors, an off-vehicle generator, a battery of the tractor 104, and/or an electronic propulsion system of the tractor 104.

The electrical output 316 may be releasably or permanently connected to the refrigeration unit 127 with a connector 322. The power conditioning interface 318 is connected to a power converter 306 that connects the switch 304 to the high voltage battery 130A. The control unit 302 may control the power converter 306 to condition the power flowing to and from the high voltage battery 130A.

The power system 300 includes a vehicle system interface 308 that permanently or releasably connects the power system 300 to a vehicle system 103 that includes a primary power supply 307. The primary power supply 307 may include the low voltage battery 130B of the vehicle 100 and the vehicle control unit or electronic control unit 120. The vehicle system interface 308 may include a power cord having one or more wires and a connector (e.g., a plug and socket) to releasably connect the power system 300 to the vehicle system 103. The control unit 302 receives electrical power from the low voltage battery 130B of the primary power supply 307 through the vehicle system interface 308. The low voltage battery 130B is the primary power source for the control unit 302 by which the control unit 302 may be electrically powered. For example, the low voltage battery 130B may be a 12V nominal voltage battery of the trailer 106 and the high voltage battery 130A may be a 400V nominal voltage battery of the trailer 106.

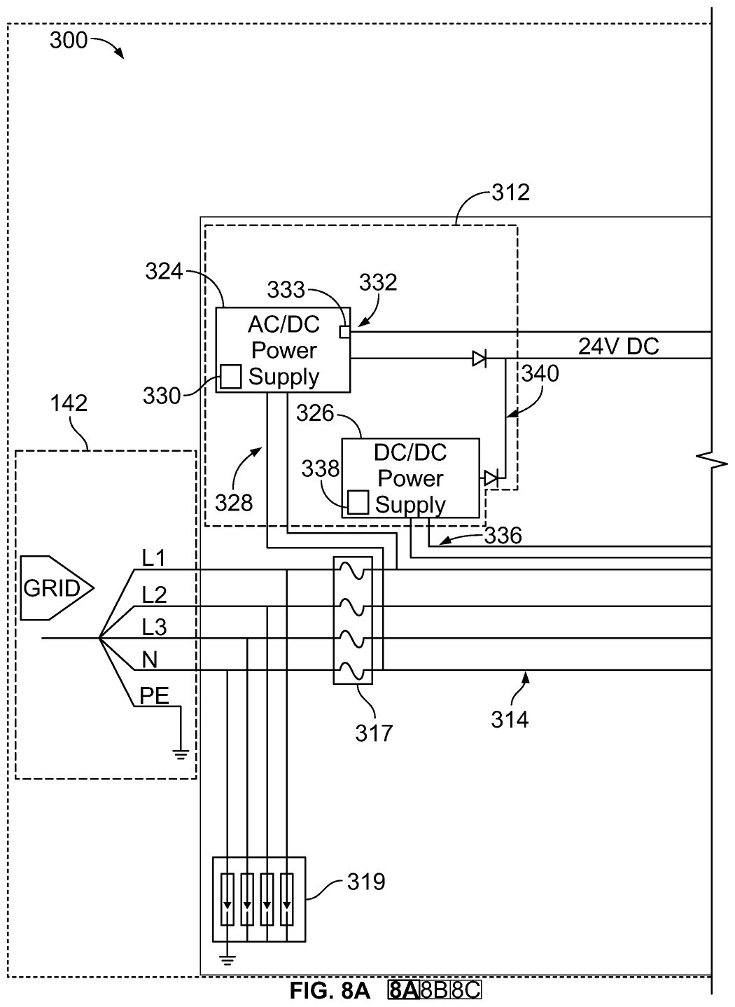

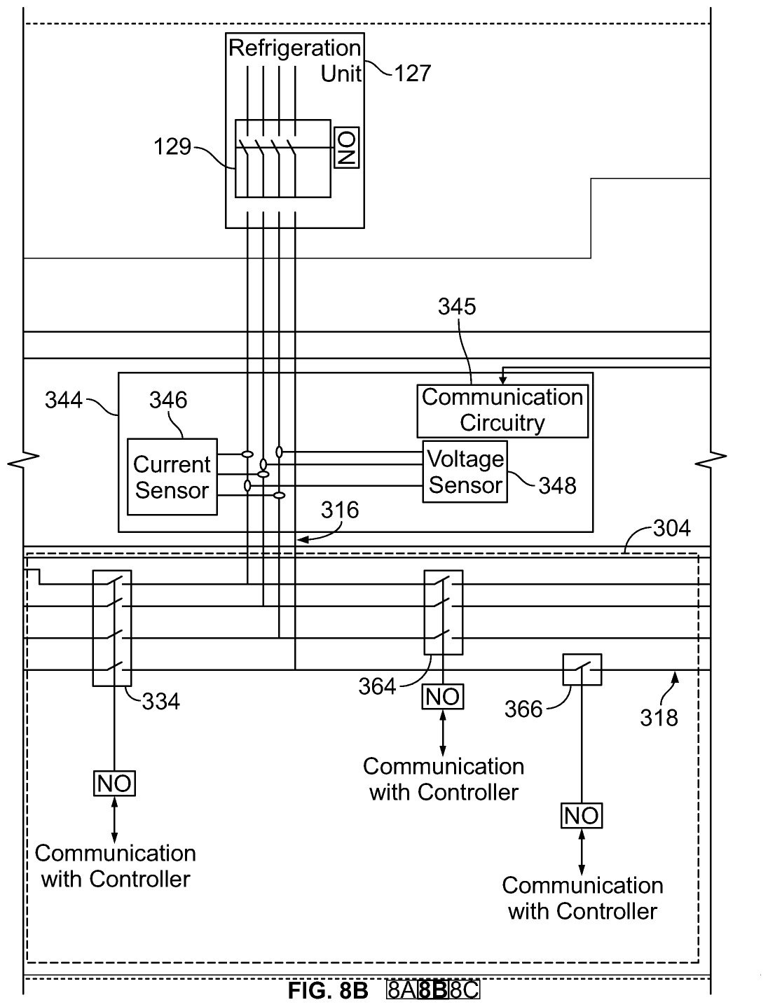

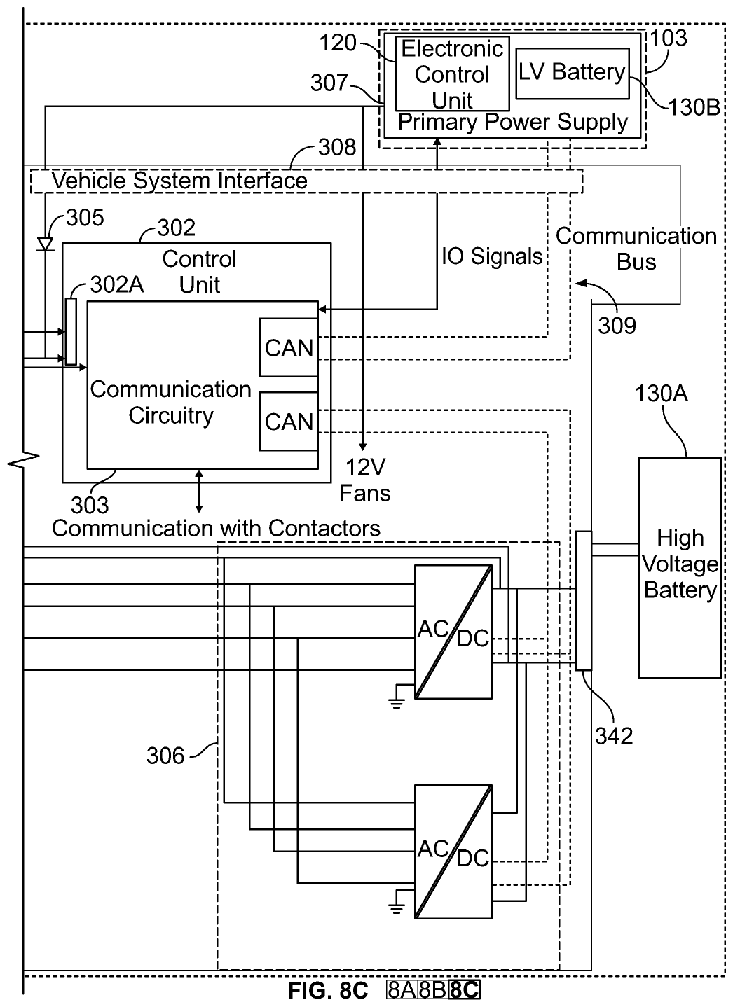

The control unit 302 may also receive a signal from the primary power supply 307, for example, the control unit 302 communicate with the electronic control unit 120 of the vehicle system 103 through the vehicle system interface 308. For example, the control unit 302 may receive control signals from the electronic control unit 120 to maintain or change the configuration of the switch 304. The control unit 302 may also receive signals from the electronic control unit 120 regarding control of the power converter 306 (e.g., to convert high voltage DC power to AC power and vice versa) to properly condition the power for use by the refrigeration unit 127 and for energy storage in the high voltage battery 130A. The electronic control unit 120 may also receive operating parameter values of the power converter from the control unit 302 including AC voltages, AC currents, DC voltage, DC current, AC frequency, temperature, etc. The vehicle system interface 308 may include one or more wires for electrical communication between the control unit 302 and the electronic control unit 120. The power system 300 may include a communication bus 309 (see FIGS. 8A-8C), such as a CAN bus, to facilitate communication between the control unit 302 and the electronic control unit 120.

The power system 300 includes an auxiliary power supply 312. The auxiliary power supply 312 is connected to the control unit 302 to electrically power the control unit 302 when power is available from an auxiliary power source, such as the high voltage battery 130A or the external power source 141. For example, the auxiliary power supply 312 may electrically power the control unit 302 when the auxiliary power supply 312 is receiving electrical power from the shore power source 142 and/or high voltage battery 130A even when power is also available from the primary power supply 307. To ensure the control unit 302 consumes the power of the auxiliary power supply 312 when power is available from both the primary power supply 307 and auxiliary power supply 312, the auxiliary power supply 312 may output power having a higher voltage than the primary power supply 307. For example, the auxiliary power supply 312 may output 24 VDC power and the primary power supply 307 may output 12 VDC power. The power system 300 may include a diode 305 (see FIG. 8C) to inhibit power from flowing from the auxiliary power supply 312 to the primary power supply 307 when power is output by the auxiliary power supply 312. Powering the control unit 302 with the auxiliary power supply 312 when power is available from an auxiliary power source (e.g., external power source 141 or high voltage battery 130A) reduces the power consumed from the low voltage battery 130B of the primary power supply 307, for example, to ensure the low voltage battery 130B is able to power other components of the vehicle 100. The control unit 302 may be powered by the primary power supply 307, however, when power is not available from the auxiliary power supply 312.

The auxiliary power supply 312 may also electrically power the control unit 302 even when the control unit 302 is not receiving electrical power from the low voltage battery 130B, for example, when the low voltage battery 130B is disconnected from the control unit 302 or the low voltage battery 130B fails. The low voltage battery 130B may fail when the low voltage battery 130B enters an error state (e.g., temperature of the battery is too high), when the state of charge is too low (e.g., due to over-discharging or aging), due to corrosion, due to damage to the terminals of the low voltage battery 130B, due to damage to the battery case, or when the low voltage battery 130B otherwise ceases to provide power to the electronic control unit 120. In one embodiment, the low voltage battery 130B is charged by a DC/DC converter that receives 400V from the high voltage battery 130A and converts the electrical power to 12V DC to charge the low voltage battery 130B when the switch 304 is in the battery power configuration.

The auxiliary power supply 312 may provide electrical power to the control unit 302 from one or more auxiliary power sources. The auxiliary power sources may include the high voltage battery 130A. Additionally or alternatively, the auxiliary power source may include the electrical input 314 of the switch 304 when the electrical input 314 is connected to the external power source 141. As discussed below, the auxiliary power supply 312 includes power conditioning circuitry to convert electrical power of the high voltage power of the battery 130A and/or external power source 141 to a condition suitable (e.g., the appropriate DC voltage) to power the control unit 302.

With respect to FIGS. 8A-8C, a schematic diagram of the power system 300 is shown. The auxiliary power supply 312 may be a low voltage power supply that outputs power at low voltage (e.g., 9-36 volts) for electronics of the power system 300, such as the control unit 302. The auxiliary power supply 312 may include an AC-to-DC power supply 324 and a DC-to-DC power supply 326. Alternatively, the auxiliary power supply 312 may include a single switched mode power supply that is able convert electrical power received from either the external power source 141 or the high voltage battery 130A to low voltage DC power to power the electronics of the power system 300, such as the control unit 302.

The AC-to-DC power supply 324 converts AC power to DC power, for example, the AC electrical power from the external power source 141 (e.g., shore power source 142) to DC power suitable to power the control unit 302. As one specific example, the AC-to-DC power supply 324 converts 277V AC single phase (e.g., line-neutral of the three-phase shore power) to 12 VDC (nominal) or 24 VDC (nominal) suitable for powering the control unit 302. The AC-to-DC power supply 324 includes an input 328, power conditioning circuitry 330, and an output 332.

The input 328 connects the electrical input 314 to the power conditioning circuitry 330. The input 328 may include one or more conductors such as a wire that extends from the electrical input 314 to the power conditioning circuitry 330. The input 328 is electrically connected to the electrical input 314 of the switch 304 such that the input 328 is electrically connected to the external power source 141 when the electrical input 314 is connected to the external power source 141. The input 328 may be connected to the electrical input 314 upstream of an input contactor 334 of the switch 304 such that power flows from the external power source 141 to the power conditioning circuitry 330 when the electrical input 314 is connected to and/or receiving power from the external power source 141 regardless of the state of the input contactor 334.

The power conditioning circuitry 330 may include rectifiers and a DC-DC converter to convert the high voltage AC power from the external power source 141 (e.g., shore power source 142) to low voltage DC power suitable to power the control unit 302. The output 332 of the AC-to-DC power supply 324 is connected to the control unit 302. The output 332 may include a conductor such as a wire that extends from the power conditioning circuitry 330 to a power input 302A of the control unit 302. The output 332 outputs the low voltage power that is generated by the power conditioning circuitry 330 of the AC-to-DC power supply 324 to the power input 302A of the control unit 302 when the input 328 is connected to the external power source 141.

With reference to FIG. 8A, the output 332 may also include a signal port 333 by which the auxiliary power supply 312 indicates whether the power output to the control unit 302 is being received from the external power source 141. The auxiliary power supply 312 outputs a signal via the signal port 333 to enable the control unit 302 to determine where the auxiliary power supply 312 is providing power from, for example, the high voltage battery 130A or the external power source 141. The AC-to-DC power supply 324 may detect the presence of electrical power at the electrical input 314 and output a signal indicating that power is available from an external power source 141 to the control unit 302.

The signal from the signal port 333 may be used as a detection signal for whether power is available from one of the external power sources 141. For example, where the external power source 141 includes an energy recovery system or energy harvesting system of the vehicle as described above, the electrical input 314 may be connected to such external power source(s), but power may not always be available. For instance, the vehicle may include a solar panel system connected to the electrical input 314, however the solar panel system may not always generate electrical power, e.g., at night. The control unit 302 may use this detection of electrical power from an external power source 141 to transition to or from the battery power configuration and the battery charging configuration.

The input 328 may be connected to the electrical input 314 downstream of fuses 317 and surge arrestors 319 of the electric power system 300. The fuses 317 may be devices that disconnect the components of the electric power system 300 from the external power source 141 in the event of excessive current flow from the external power source 141 into the electric power system 300. The surge arrestors 319 may be devices that limit the high voltage produced by an abnormal event (e.g., from lightning) on the electrical system from flowing into the electric power system 300 by discharging or bypassing surge current flowing from the external power source 141 toward the electric power system 300. The fuses 317 and surge arrestors 319 thus protect the electric power system 300 from potential damage by voltage and current surges from the external power source 141.

The DC-to-DC power supply 326 converts high voltage DC power to low voltage DC power, for example, the electrical power from the high voltage battery 130A to DC power suitable to power the control unit 302. As one specific example, the DC-to-DC power supply 326 converts 270V DC-400V DC voltage of the high voltage battery 130A to 12 VDC or 24 VDC suitable for powering the control unit 302. The DC-to-DC power supply 326 includes an input 336, power conditioning circuitry 338, and an output 340.

The input 336 connects the high voltage battery 130A to the power conditioning circuitry 338. The input 336 may include one or more conductors such as wires that extend from the high voltage battery 130A to the power conditioning circuitry 338. The input 336 is electrically connected to the high voltage battery 130A such that the input 336 and power conditioning circuitry 338 connected thereto receive electrical power from the high voltage battery 130A when a battery interface 342 of the electric power system 300 is connected to the high voltage battery 130A and the high voltage battery 130A is charged.

The power conditioning circuitry 338 may include a transformer (e.g., a high frequency transformer) to convert the high voltage DC power from the high voltage battery 130A to low voltage DC power suitable to power the control unit 302. The output 340 of the DC-to-DC power supply 326 is electrically connected to the control unit 302. The output 340 may include one or more conductors such as wires that extend from the power conditioning circuitry 338 to a power input 302A of the control unit 302. The output 332 outputs the low voltage power that is generated by the power conditioning circuitry 338 of the DC-to-DC power supply 326 to the power input 302A of the control unit 302 when the high voltage battery 130A is providing power to the DC-to-DC power supply 326.

The power system 300 may include an overload relay 344 electrically connected between the switch 304 and the refrigeration unit 127. The overload relay 344 may monitor the power flowing to the refrigeration unit 127 and protect the refrigeration unit from any abnormal voltages or currents. The overload relay 344 may be used to protect the refrigeration unit 127 from abnormal power conditions such as overvoltage, overcurrent, and unbalanced voltages and/or currents. The overload relay 344 includes a current sensor 346 and a voltage sensor 348 that may be used to monitor the current and voltage of the power flowing from the switch 304 to the refrigeration unit 127. The overload relay 344 may be in communication with the control unit 302. The overload relay 344 may include communication circuitry 345 that communicates with communication circuitry 303 of the control unit 302 over one or more communication protocols, for example, Ethernet Modbus TO/IP. The control unit 302 may receive signals from the current sensor 346 and/or voltage sensor 348 to detect abnormal current and/or voltage conditions. The overload relay 344 may include contactors which may be opened to disconnect refrigeration unit 127 from the high voltage power of the external power source 141 or high voltage battery 130A in the event of abnormal voltages/currents. Additionally or alternatively, the control unit 302 may control the switch 304 to inhibit electrical power from flowing through the switch 304 to the refrigeration unit 127 in response to detecting abnormal power conditions. The overload relay 344 may also use the current sensor 346 and/or voltage sensor 348 to determine the amount of power consumed by the refrigeration unit 127 from an external power source 141, for example, to determine whether to enter the external power and charging configuration to also charge the battery 130A.

The auxiliary power supply 312 may provide electrical power to the power input 302A of the control unit 302 and electrically power the control unit 302 whenever electrical power is available from one or more auxiliary power sources, such as the electrical input 314 and/or high voltage battery 130A as discussed above. In the absence of electrical power from the auxiliary power supply 312, the primary power supply 307 provides electrical power to the power input 302A of the control unit 302. The primary power supply 307 operates as a dedicated power supply for the control unit 302 when the auxiliary power supply 312 is unable to provide electrical power to the control unit 302. In this manner, the control unit 302 is able to control the flow of electricity to the refrigeration unit 127 of the vehicle 100 and keep the contents of the vehicle 100 below a threshold temperature.

The primary power supply 307 includes the electronic control unit 120 of the vehicle 100 as shown in FIG. 8C. In one embodiment, the primary power supply 307 provides both a communication signal and a power signal to the control unit 302. The control unit 302 may be connected to the primary power supply 307 of the vehicle system 103 by the vehicle system interface 308. The primary power supply 307 may send commands to the control unit 302 regarding setting the configuration of the switch 304 and/or control of the power converter 306 to condition the power flowing to or from the high voltage battery 130A. For instance, the primary power supply 307 may monitor the condition of the high voltage battery 130A (e.g., charge level, temperature) and determine whether to power the refrigeration unit 127 with the high voltage battery 130A or permit charging of the high voltage battery 130A. The control unit 302 may send signals to the primary power supply 307 regarding faults detected by power converter 306.

The control unit 302 may be in communication with the input contactors 334 and power conditioning contactors 364 of the switch 304. The control unit 302 may send control signals to the input contactors 334 and/or power conditioning contactors 364 to open or close the contactors. For example, the control unit 302 may send a control signal to a relay associated with the contactors to close or open the contactors 334, 364. As another example, one or both of the contactors 334, 364 may close in response to receiving a control signal from the control unit 302 and may open in the absence of the control signal. The input contactors 334 and power conditioning contactors 364 may communicate their state (e.g., open or closed) to the control unit 302 as feedback to the control unit 302 which permits the control unit 302 to determine the current configuration of the switch 304.

The switch 304 may include a separate neutral line output contactor 366. The neutral line output contactor 366 may be separately controlled based on the configuration of the switch 304. For example, when the switch 304 is in the battery power configuration, the control unit 302 may close the neutral line output contactor 366 along with the power conditioning contactors 364 whereas when the switch 304 is in the battery charging configuration the control unit 302 may open the neutral line output contactor 366 while closing the power conditioning contactors 364.

The control unit 302 may operate in a normal mode or an isolation mode. The control unit 302 may operate in the normal mode when receiving a communication signal from the primary power supply 307. The control unit 302 may operate in the isolation mode when the communication signal from the primary power supply 307 is lost or not present such that the control unit 302 is not receiving a communication signal from the primary power supply 307. Although the communication signal from the primary power supply 307 is lost, the control unit 302 in the isolation mode thereof may still be electrically powered by the auxiliary power supply 312 as discussed above. Because the control unit 302 remains electrically powered by the auxiliary power supply 312, the control unit 302 is able to continue controlling the switch 304 to power the refrigeration unit 127 using the external power source 141 even when the communication signal from the primary power supply 307 is lost (as discussed below). More specifically, when the control unit 302 is not receiving the communication signal from the primary power supply 307, the control unit 302 is configured to energize or de-energize contactor 334, but the control unit 302 cannot energize or de-energize the contactor 364.

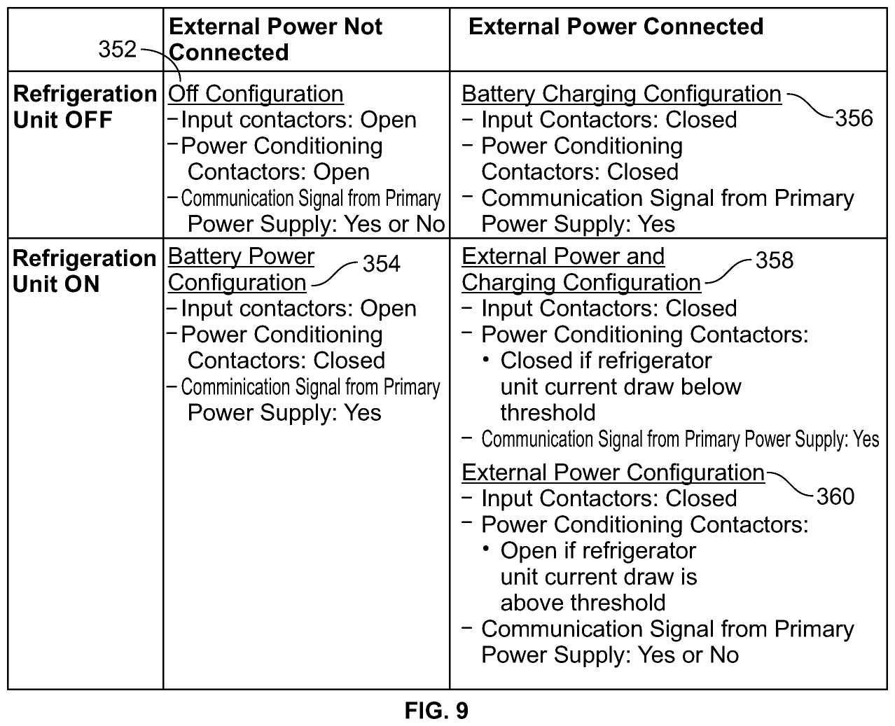

With reference to FIG. 9, the control unit 302 may set the configuration of the switch 304 based on whether the communication signal from the primary power supply 307 is present. When in the normal mode, the control unit 302 is receiving the power signal and communication signal from the primary power supply 307. The control unit 302 may set the configuration of the switch 304 based on communications with the electronic control unit 120 of the primary power supply 307, the presence of the external power source 141, and whether the refrigeration unit 127 has sent a run request or is currently running.

Specifically, when the electrical input 314 is not receiving power from the external power source 141 and the refrigeration unit 127 is off, the control unit 302 may set the switch 304 to the off configuration 352 where the input contactors 334 and power conditioning contactors 364 are open so that current is not able to flow through the switch 304. The control unit 302 may set the switch to the off configuration 352 whether or not the control unit 302 receives a communication signal from the primary power supply 307. In other words, the control unit 302 is able to set the switch 304 to the off configuration 352 whether the control unit 302 is in the normal mode or the isolation mode.

The control unit 302 may set the switch 304 to a battery charging configuration 356 to charge the battery 130A from the external power source 141. In the battery charging configuration 356, the input contactors 334 and power conditioning contactors 364 are closed. The control unit 302 operating in the normal mode receives the communication signal from the primary power supply 307 and is therefore able to set the switch 304 to the battery charging configuration 356, but not when the control unit 302 is in the isolation mode as discussed below.

The control unit 302 in the normal mode may set the switch 304 to a battery power configuration 354 to power the refrigeration unit 127 of the vehicle with the battery 130A. The switch 304 may be set to the battery power configuration 354 upon detecting that the switch 304 is not connected to or receiving power from the external power source 141 and the refrigeration unit 127 has sent a run request to the control unit 302 and/or the refrigeration unit 127 is drawing current from the switch 304. In the battery power configuration 354, the input contactors 334 are open and the power conditioning contactors 364 are closed. In the battery power configuration 354, the refrigeration unit 127 draws power from the battery 130A to run the refrigeration unit 127. The control unit 302 operating in the normal mode receives the communication signal from the primary power supply 307 and is therefore able to set the switch 304 to the battery power configuration 354, but not when the control unit 302 is in the isolation mode as discussed below.

The control unit 302 in the normal mode may set the switch 304 to an external power and charging configuration 358 to power the refrigeration unit 127 and charge the battery 130A. The switch 304 may be set to the external power and charging configuration 358 when the switch 304 is connected to and/or receiving power from the external power source 141 and the refrigeration unit 127 is running (e.g., the motor is operating) and drawing less than a predetermined amount of current, for example, as described above with respect to FIG. 4. In the external power and charging configuration 358, the battery 130A is charged by the external power source 141 while the refrigeration unit 127 is also powered by the external power source 141. The control unit 302 operating in the normal mode receives the communication signal from the primary power supply 307 and is therefore able to set the switch 304 to the external power and charging configuration 358, but not when the control unit 302 is in the isolation mode as discussed below.

The control unit 302 in the normal mode or isolation mode may set the switch 304 to an external power configuration 360 to power the refrigeration unit 127 from the external power source 141 and not charge the battery 130A. The control unit 302 may set the switch 304 to the external power configuration 360 upon the control unit 302 receiving a run request or detecting the refrigeration unit 127 is drawing more than a predetermined amount of current, for example, as described above with respect to FIG. 4.

Where the communication signal from the primary power supply 307 is lost, the control unit 302 operates in the isolation mode. The control unit 302 may have limited control of the switch 304 in the isolation mode relative to the normal mode. In the isolation mode, the control unit 302 may inhibit the switch 304 from being set to configurations that allow power to flow to or from the high voltage battery 130A such as the battery power configuration 354, the battery charging configuration 356, and external power and charging configuration 358. For example, if the control unit 307 cannot receive the communication signal from the primary power supply 307, the control unit 302 may be unable determine the state of charge level, temperature, or other characteristics of the battery 130A used to determine whether the battery 130A is able to be charged and/or whether the battery 130A may be used to power the refrigeration unit 127. The isolation mode thereby inhibits the control unit 302 from directing electrical power to or drawing electrical power from the high voltage battery 130A.

In the isolation mode, the control unit 302 may set the switch 304 to the external power configuration 360 to power the refrigeration unit 127 with the power from the external power source 141. The control unit 302 may receive a signal from the signal port 333 of the auxiliary power supply 324 that indicates whether the electrical input 314 is receiving external power from the external power source 141. The control unit 302 may set the switch to the external power configuration 360 upon detecting the electrical input 314 is receiving external power to provide power to the refrigeration unit 127. The control unit 302 may check if the output contactors 364 of switch 304 are open before closing the input contactors 334 to place the switch 304 into the external power configuration 360 to ensure there is no power flow between the switch 304 and the high voltage battery 130A. Thus, when the refrigeration unit 127 begins to operate (e.g., to cool an enclosed area of the vehicle 100), the refrigeration unit 127 may close a switch 129 (see FIG. 8B) to begin receiving electrical power from the switch 304 to power the motor of the refrigeration unit 127. The control unit 302 may set the switch 304 to the off configuration 352 upon detecting the electrical input 314 is not connected to the external power source 141 or otherwise is not receiving power from the external power source 141.

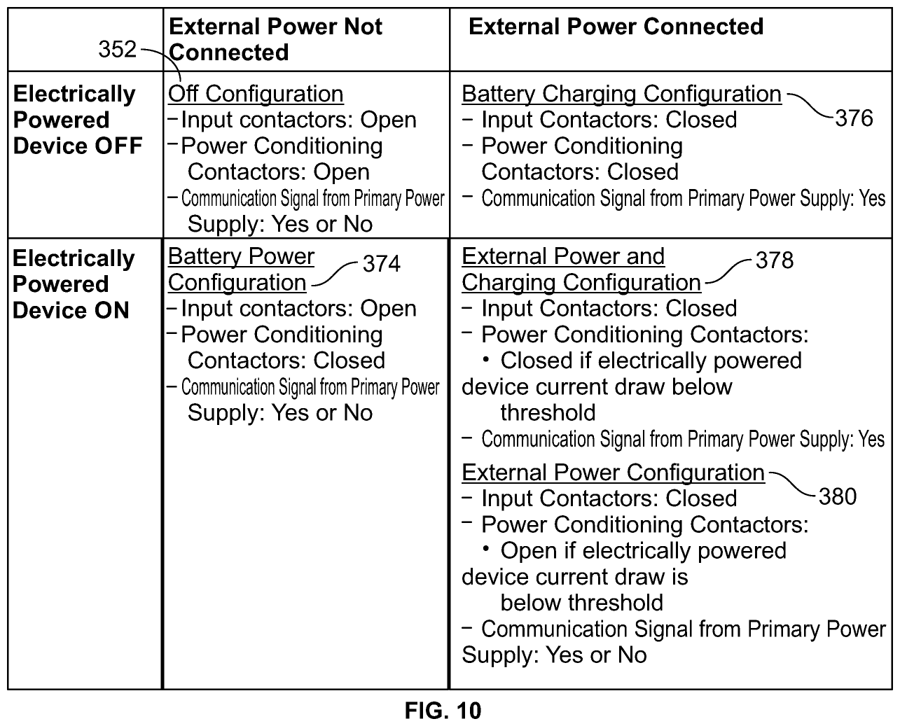

With respect to FIG. 10, the electric power system 300 may similarly be used to provide electrical power to other types of electrically powered devices 125 of a vehicle connected to the electrical output 316 of the switch 304. Electrically powered devices 125 of the vehicle may include electrically powered devices such as, for example, an electric liftgate, electric excavator, electric compact wheel loader, an electric motor of a crusher, an electric plunger pump, electric motors of elevators and/or conveyors, an electric motor of grinding machines, flour mills, lathe machines, steel mills, line shafts, an electric motor of a concrete mixer, an electric motor or hydraulic pump of a crane body, a heater, an electric-hydraulic cylinder of a dump trailer, pumps, lights, etc. The control unit 302 may control the configuration of the switch 304 to permit electrical power to flow from the external power source 141 to the high voltage battery 130A and/or electrically powered device 125 of the vehicle 100. The control unit 302 further controls the configuration of the switch 304 to permit electrical power to flow from the high voltage battery 130A to the electrically powered device 125.

The control of the switch 304 by the control unit 302 when different electrically powered devices 125 are utilized may be similar in many respects to the control of the switch 304 described above with respect to FIG. 9. When an electrically powered device 125 is connected to the electrical output 316 of the switch 304, the configuration of the switch 304 may be set to power the electrically powered device 125 based on the operation of the electrically powered device 125. When the external power source 141 is not connected and the electrically powered device 125 is off or not drawing power, the control unit 302 may set the switch 304 to the off configuration 372. When the external power source 141 is connected and the electrically powered device 125 is off or not drawing power, the switch 304 may be set to the battery charging configuration 376 to charge the battery 130A from the external power source 141.

The switch 304 may be set to a battery power configuration 374 to power the electrically powered device 125 with the battery 130A, for example, upon detecting that the switch 304 is not connected to the external power source 141, the electrically powered device 125 is on and/or drawing current from the switch 304, and the battery 130A has a sufficient state of charge to discharge itself and power the electrically power device 125. The switch 304 may be set to the external power and charging configuration 378 to power the electrically powered device 125 and charge the battery 130A, for example, when the switch 304 is connected to the external power source 141 and the electrically powered device 125 is running (e.g., a hydraulic motor of the electrically powered device 125 is operating) and drawing less than a predetermined amount of current. The switch 304 may be set to the external power configuration 380 to power the electrically powered device 125 from the external power source 141 and not charge the battery 130A upon detecting the electrically powered device 125 is drawing more than a predetermined amount of current. As discussed above with respect to FIG. 9, the control unit 302 may set the switch 304 to the configurations 372, 374, 376, 378, 380 when the control unit 302 is in the normal mode, but may only be able to set the switch to the configurations 372, 380 when the control unit 302 is in the isolation mode.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B.

While there have been illustrated and described particular embodiments of the present invention, it will be appreciated that numerous changes and modifications will occur to those skilled in the art, and it is intended for the present invention to cover all those changes and modifications which fall within the scope of the appended claims.

1. An electrical power apparatus for a vehicle, the electrical power apparatus comprising:
an electrical input to receive electrical power from an external power source;
an electrical output to provide electrical power to an electrically powered device of the vehicle;
a battery interface to provide electrical power to a battery of the vehicle and to receive electrical power from the battery; and
a switch operatively connected to the electrical input, the electrical output, and the battery interface, the switch having a plurality of configurations comprising:
a battery charging configuration wherein the electrical input and the battery interface are electrically connected to permit the battery interface to receive electrical power from the electrical input; and
a battery power configuration wherein the battery interface and the electrical output are electrically connected to permit the electrical output to receive electrical power from the battery interface.

2. The electrical power apparatus of claim 1 including a control unit configured to set the switch to one of the plurality of configurations based upon a determination of whether the external power source is able to provide electrical power to the electrical input.

3. The electrical power apparatus of claim 1 wherein the external power source includes a shore power source;
wherein the electrical input is configured to be releasably connected to the shore power source; and
a control unit configured to set the switch to the battery charging configuration based at least in part upon whether the electrical input is connected to the shore power source.

4. The electrical power apparatus of claim 1 comprising:
a sensor configured to detect a variable of the electrically powered device; and
a control unit operatively connected to the sensor, the control unit configured to set the switch to one of the plurality of configurations based upon whether the external power source is able to provide electrical power to the electrical input and the variable of the electrically powered device.

5. The electrical power apparatus of claim 1 wherein the plurality of configurations of the switch comprises an external power configuration wherein the electrical input and the electrical output are electrically connected to permit the electrical output to receive electrical power from the electrical input.

6. The electrical power apparatus of claim 5 comprising:
a sensor configured to detect a variable of the electrically powered device; and
a control unit operatively connected to the sensor, the control unit configured to set the switch to the external power configuration upon a determination of the external power source being able to provide electrical power to the electrical input and the variable of the electrically powered device satisfying an external power configuration condition.

7. The electrical power apparatus of claim 1 wherein the plurality of configurations of the switch comprises an external power and charging configuration wherein the electrical input, the electrical output, and the battery interface are electrically connected to permit the electrical output and the battery interface to receive electrical power from the external power source.

8. The electrical power apparatus of claim 7 comprising:
a sensor configured to detect a variable of the electrically powered device; and
a control unit operatively connected to the sensor, the control unit configured to set the switch to the external power and charging configuration upon a determination of the external power source being able to provide electrical power to the electrical input and the variable of the electrically powered device satisfying an external power and charging configuration condition.

9. The electrical power apparatus of claim 1 wherein the plurality of configurations of the switch comprises an external power configuration wherein the electrical input and the electrical output are electrically connected to permit the electrical output to receive electrical power from the electrical input;
the control unit having a normal mode wherein the control unit is operable to set the switch to any one of the plurality of configurations;
the control unit having an isolation mode wherein the control unit is unable to set the switch to either the battery charging configuration or the battery power configuration; and
the control unit configured to change from the normal mode to the isolation mode in response to the control unit not receiving a signal from a primary power supply.

10. The electrical power apparatus of claim 9 in combination with an auxiliary power supply, the auxiliary power supply comprising:
an input to receive electrical power from the external power source;
an output operatively connected to the control unit;
power conditioning circuitry configured to condition the electrical power received at the input to an electrical power suitable for being provided to the control unit; and
wherein the control unit is configured to receive electrical power from the primary power supply of the vehicle or the auxiliary power supply.

11. The electrical power apparatus of claim 1 wherein the plurality of configurations of the switch comprises an external power configuration wherein the electrical input and the electrical output are electrically connected to permit the electrical output to receive electrical power from the electrical input;
a control unit configured to receive a signal from a primary power supply of the vehicle;
the control unit having a normal operating mode wherein the control unit is able to set the switch to any of the plurality of configurations and an isolation mode wherein the control unit is unable to set the switch to either the battery charging configuration or the battery power configuration; and
the control unit configured to reconfigure from the normal mode to the isolation mode in response to the control unit not receiving the signal from the primary power supply of the vehicle.

12. The electrical power apparatus of claim 1 further comprising a proximity sensor configured to detect whether the electrical input is connected to the external power source.

13. The electrical power apparatus of claim 1 wherein the external power source includes a shore power source; and
wherein the electrical input is configured to receive electrical power from the shore power source.

14. The electrical power apparatus of claim 1 wherein the electrical input is configured to receive 480 volt, three phase alternating current power from the external power source.

15. The electrical power apparatus of claim 1 in combination with a regenerative braking system comprising an electric generator configured to provide electrical power to the battery.

16. The electrical power apparatus of claim 1 in combination with the external power source, the external power source including at least one of:
an engine exhaust energy harvesting system;
a dynamic energy harvesting system;
a solar power system;
a wind turbine system;
a three-phase inverter with an external battery;
a three-phase inverter with an ultracapacitor;
an off-vehicle generator; and
an electronic propulsion system.

17. The electrical power apparatus of claim 1 in combination with the electrically powered device, the electrically powered device including a refrigeration unit.

18. The electrical power apparatus of claim 1 wherein the electrical output includes an overload relay to protect the electrically powered device.

19. A method of operating an electrical power apparatus of a vehicle having a battery and an electrically powered device, the method comprising:
detecting a variable of the electrically powered device;
determining whether an external power source is able to provide electrical power to an electrical input of the electrical power apparatus; and
setting a switch of the electrical power apparatus to one of a plurality of configurations based at least in part on the variable of the electrically powered device and whether the external power source is able to provide electrical power to the electrical input of the electrical power apparatus, the plurality of configurations comprising:
a battery charging configuration wherein the electrical input and the battery are electrically connected to permit the battery to receive electrical power from the external power source; and
a battery power configuration wherein the battery and the electrically powered device are electrically connected to permit the electrically powered device to receive electrical power from the battery.

20. The method of claim 19 wherein setting the switch comprises setting the switch to the battery charging configuration upon the variable of the electrically powered device indicating the electrically powered device is in a standby state and the external power source being able to provide electrical power to the electrical input.

21. The method of claim 19 wherein setting the switch comprises setting the switch to the battery power configuration upon the variable of the electrically powered device indicating the electrically powered device is in a run state and the external power source being unable to provide electrical power to the electrical input.

22. The method of claim 19 wherein detecting the variable of the electrically powered device comprises at least one of:
detecting a current draw of the electrically powered device; and
receiving a run request from the electrically powered device.

23. The method of claim 19 wherein the plurality of configurations further comprises an external power configuration wherein the electrical input and the electrically powered device are electrically connected to permit the electrically powered device to receive electrical power from the external power source.

24. The method of claim 23 wherein setting the switch comprises setting the switch to the external power configuration upon the external source being able to supply electrical power to the electrical input and the variable of the electrically powered device satisfying an external power configuration condition.

25. The method of claim 19 wherein the plurality of configurations further comprises an external power and charging configuration wherein the electrical input, the electrically powered device, and the battery are electrically connected to permit the electrically powered device and the battery to receive electrical power from the external power source.

26. The method of claim 25 wherein setting the switch comprises setting the switch to the external power and charging configuration upon the external power source being able to provide electrical power to the electrical input and the variable of the electrically powered device satisfying an external power and charging configuration condition.

27. The method of claim 19 wherein the plurality of configurations further comprises an external power configuration wherein the electrical input and the electrically powered device are electrically connected to permit the electrically powered device to receive electrical power from the external power source;
determining whether a control unit configured to set the switch to the one of the plurality of configurations is receiving a signal from a primary power supply of the vehicle,
wherein setting the switch is based at least in part on whether the control unit is receiving the signal; and
wherein setting the switch comprises inhibiting the switch from being in either the battery charging configuration or the battery power configuration upon determining a loss of the signal from the primary power supply.

28. The method of claim 27 further comprising receiving electrical power at the control unit from an auxiliary power supply when power is not available from the primary power supply.

29. The method of claim 19 wherein the variable of the electrically powered device comprises a run state of the electrically powered device.

30. The method of claim 19 wherein determining whether the external power source is able to provide electrical power to the electrical input comprises using a proximity sensor to detect whether the electrical input is connected to the external power source.

31. The method of claim 19 further comprising providing electrical power to the battery from a regenerative braking system of the vehicle.

32. A vehicle system comprising:
a regenerative braking system comprising a battery;
an electrical input configured to be connected to an external power source;
an electrically powered device;
a switch operatively connected to the battery, the electrical input, and the electrically powered device, the switch having a plurality of configurations including:
a battery charging configuration wherein the electrical input and the battery are electrically connected to permit the battery to receive electrical power from the external power source; and
a battery power configuration wherein the battery and the electrically powered device are electrically connected to permit the electrically powered device to receive electrical power from the battery;
a control unit configured to set the switch to one of the plurality of configurations based at least in part on a variable of the electrically powered device and a determination of whether the external power source is able to provide electrical power to the electrical input.

33. The vehicle system of claim 32 wherein the control unit is configured to set the switch to the battery charging configuration upon the variable of the electrically powered device indicating that the electrically powered device is in a standby state and the external power source being able to provide electrical power to the electrical input.

34. The vehicle system of claim 32 wherein the control unit is configured to set the switch to the battery power configuration upon the variable of the electrically powered device indicating the electrically powered device is in a run state and the external power source being unable to provide electrical power to the electrical input.

35. The vehicle system of claim 32 further comprising a sensor configured to detect a current draw of the electrically powered device; and
wherein the variable of the electrically powered device is indicative of the current draw.

36. The vehicle system of claim 32 wherein the plurality of configurations of the switch further comprises an external power configuration wherein the electrical input and the electrically powered device are electrically connected to permit the electrically powered device to receive electrical power from the external power source.

37. The vehicle system of claim 36 wherein the control unit is configured to set the switch to the external power configuration upon the external power source being able to provide electrical power to the electrical input and the variable of the electrically powered device satisfying an external power configuration condition.

38. The vehicle system of claim 32 wherein the plurality of configurations of the switch further comprises an external power and charging configuration wherein the electrical input, the electrically powered device, and the battery are electrically connected to permit the electrically powered device and the battery to receive electrical power from the external power source.

39. The vehicle system of claim 38 wherein the control unit is configured to set the switch to the external power and charging configuration upon the electrical power source being able to provide electrical power to the electrical input and the variable of the electrically powered device satisfying an external power and charging configuration condition.

40. The vehicle system of claim 32 wherein the plurality of configurations of the switch further comprises an external power configuration wherein the electrical input and the electrically powered device are electrically connected to permit the electrically powered device to receive electrical power from the external power source;
the control unit having a normal mode wherein the control unit is operable to set the switch to any one of the plurality of configurations;
the control unit having an isolation mode wherein the control unit is unable to set the switch to either the battery charging configuration or the battery power configuration; and
wherein the control unit is configured to change from the normal mode to the isolation mode in response to the control unit not receiving a signal from a primary power supply.

41. The vehicle system of claim 40 in combination with an auxiliary power supply, the auxiliary power supply comprising:
an input to receive electrical power from the external power source;
an output operatively connected to the control unit;
power conditioning circuitry configured to condition the electrical power received at the input to an electrical power for being provided to the control unit; and
wherein the control unit is configured to receive electrical power from the primary power supply of the vehicle or the auxiliary power supply.

42. The vehicle system of claim 32 wherein the plurality of configurations of the switch comprises an external power configuration wherein the electrical input and the electrical output are electrically connected to permit the electrical output to receive electrical power from the electrical input;
the control unit having a normal operating mode wherein the control unit is able to set the switch to any of the plurality of configurations and an isolation mode wherein the control unit is unable to set the switch to either the battery charging configuration or the battery power configuration; and
the control unit configured to reconfigure from the normal mode to the isolation mode in response to the control unit not receiving a signal from a primary power supply of the vehicle.

43. The vehicle system of claim 32 wherein the electrically powered device includes a refrigeration unit.

44-50. (canceled)
